(19) United States
(12) Patent Application Publication
(10) Pub. No.: US 2015/0161554 A1
(43) Pub. Date: Jun. 11, 2015

(54) INTELLIGENT DISPATCH SYSTEM FOR SELECTING SERVICE PROVIDERS

(71) Applicant: Uber Technologies, Inc., San Francisco, CA (US)

(72) Inventors: Matthew Sweeney, San Francisco, CA (US); Amos Barreto, San Francisco, CA (US); Sophia Cui, San Francisco, CA (US); Laszlo Korsos, San Francisco, CA (US)

(21) Appl. No.: 14/566,190

(22) Filed: Dec. 10, 2014

Related U.S. Application Data
(60) Provisional application No. 61/914,890, filed on Dec. 11, 2013.

(51) Int. Cl. G06Q 10/06; G06Q 50/30

(52) U.S. Cl. CPC G06Q 10/063114; G06Q 50/30

(57) ABSTRACT

A system and method for arranging a transport service is described. A server can receive a request for transport from a computing device of a first user. The request can include information about a pickup location of the first user. In response to receiving the request, the server can determine a plurality of drivers that are capable of providing transport for the first user by determining a first set of drivers that are each driving a vehicle that is unoccupied by other users, and determining a second set of drivers that are each providing transport service to one or more other users to a respective destination location that is within a threshold distance or threshold estimated travel time from the pickup location of the first user. The server can select a first driver from the plurality of drivers to provide the transport service for the first user.

### RELATED APPLICATIONS

This application is a non-provisional filing that claims the benefit of U.S. Provisional Patent Application No. 61/914,890, filed Dec. 11, 2013, titled INTELLIGENT DISPATCH SYSTEM FOR SELECTING SERVICE PROVIDERS; the aforementioned application being incorporated by reference in its entirety.

### BACKGROUND

On-demand services exist that arrange for transport to be provided for a user by a driver of a vehicle. For example, in many cases, a user that requests a transport service may be provided the first available driver or the closest driver to the user's requested pickup location.

### BRIEF DESCRIPTION OF THE DRAWINGS

FIG. 1A illustrates an example system to arrange an on-demand service, in one example.

FIG. 1B illustrates a first implementation of an optimization sub-system for selecting a driver of a transport request in a manner that optimizes the time to pick up for that transport request, according to an example.

FIG. 1C illustrates a second implementation of an optimization sub-system for selecting a driver of a transport request in a manner that collectively optimizes the time to pick up for a group of transport request, according to an example.

FIG. 2 illustrates an example method for arranging an on-demand service for a user, according to an example.

FIGS. 3A and 3B illustrate example methods for determining providers capable of providing an on-demand service, according to an example.

FIG. 4 illustrates a method for optimizing the selection of drivers (or vehicles) for transport requests, according to one or more example.

FIG. 5A illustrates an example sequence diagram for a driver assignment and subsequent change based on optimization considerations, according to an example.

FIG. 5B illustrates another example sequence diagram of a trip (or driver) swap based on optimization considerations, according to another example.

FIG. 6A through FIG. 6C illustrate examples for implementation of a driver selection algorithm in which driver/rider pairings are made with an optimization objective of minimizing time to pick up, according to one or more examples.

FIG. 7 is a block diagram that illustrates a computer system upon which examples described herein may be implemented.

FIG. 8 is a block diagram that illustrates a mobile computing device upon which examples described herein may be implemented.

### DETAILED DESCRIPTION

Examples described herein provide for an intelligent on-demand service dispatch system that optimizes the selection of a service provider for a user requesting an on-demand service. In at least some examples, when a request for an on-demand service is made by a user, the system can determine a plurality of service providers that are capable of providing the on-demand service for the user based on location information provided by the user and current status and/or location information of the service providers.

In some examples, when the system receives a transport request from a user, the system can select a driver that is already providing transport to another customer if that driver is best suited for providing transport to the user (e.g., despite other available drivers that are unoccupied by users). For example, the system can determine that a driver will drop off his or her customer at a location that is proximate to the requesting user's pickup location at a certain time. In another example, the system can determine that the current location (and/or locations along a predicted driving route) of a driver is proximate to the requesting user's pickup location, and that the destination of the requesting user is proximate to the destination of the driver's current customer. The system can determine such drivers to be optimal candidates for providing transport to a requesting user.

According to some examples, the system can receive a request for transport from a computing device of a first user. The request for transport can include information about a pickup location of the first user. In response to receiving the request for transport, the system can determine a plurality of drivers that are capable of providing transport for the first user. The system can determine the plurality of drivers by determining a first set of drivers that are each driving a vehicle that is unoccupied by other users (e.g., drivers that are active or on duty, but not in-use) and determining a second set of drivers that are each providing transport service to other user(s) to a respective destination location that is within a threshold distance or threshold estimated travel time from the pickup location of the first user. The system can select a first driver from the plurality of drivers to provide the transport service for the first user.

In one example, the system determines the first set of drivers that are driving vehicles unoccupied by other users by identifying such drivers having a current location within a predefined distance of the pickup location of the first user or within a predefined region of the pickup location of the first user. For example, the predefined distance or region can relate to or correspond to a city or city limits, or a geographical area in which the user's pickup location is located. An available driver that is one hundred miles away from the user's pickup location, for example, would be determined to not be within the predefined distance (e.g., fifteen miles) of the user's pick up location, and therefore, would not be determined to be capable of providing transport for the first user.

In another example, the system can also determine the second set of drivers by (i) identifying in-use drivers (e.g., drivers that are already providing transport service to other users) having a current location within the predefined distance or predefined region of the pickup location of the first user, (ii) for each identified driver, determining a first estimated travel time from that respective destination location to the pickup location of the first user, and (iii) for each identified driver, comparing the first estimated travel time with the threshold estimated travel time.

According to examples, the system can determine information about drivers by periodically monitoring or tracking the status and location of individual drivers, and/or receiving status information from individual drivers at various times. For example, each driver in the first set of drivers can update his or her status and provide the updated status to the system indicating to the system that the driver is available to provide transport service (e.g., is active or on duty, but not-in use). For instance, the driver may have just finished dropping off a user at a destination or may have gotten off break or just started his or her shift, and can then update his or her status using a respective computing device.

In some examples, the system can also receive destination location information from drivers that are currently providing transport to users. An in-use driver that is transporting a customer can input the destination location to his or her computing device (e.g., using a designated application), which then provides the destination information to the system. The system can use the destination information to determine if that driver is a viable candidate that is capable of providing transport for another requesting user.

According to some examples, a system and method are provided to optimize the selection of drivers for providing transport. The optimization performed in selecting drivers for transport requests can include using an optimization objective that minimizes the time to pick up for transport requests on either an individual or a group basis.

According to another aspect, a computing system operates to process multiple transport requests at one time, each of the multiple transport request specifying a pickup location that is within a geographic region. During a given interval when each of the multiple transport request are open, a pool of candidate drivers is determined within the geographic region that can fulfill one or more of the transport requests within a threshold duration of time. A driver is selected for each of the multiple transport requests. In selecting the driver, the computer system implements an optimization process to minimize an estimated time to pick up for at least one of the multiple transport requests.

According to one aspect, the optimization process includes minimizing an aggregation of an estimated time to pick up for at least some of the multiple transport requests based on a pool of drivers. In a variation, the optimization process includes minimizing a time to pick up for an individual transport request based on the pool of drivers.

Still further, some variations provide for increasing the pool of drivers by allowing for driver reassignment(s) after selection of drivers has been made. Various types of reassignments can be made, including switching drivers for a given transport request or swapping drivers amongst two transport request. In variations, the reassignments can be made in response to one or more optimization determinations.

The terms “optimal,” “optimize,” or variants thereof are intended to mean an act of achieving, through intelligent and deliberate consideration, a result or outcome that is more desired as to a particular facet or parameter. The use of such terms in reference to a given process does not necessarily mean that a result or outcome is achieved that is most optimal, but rather can mean the result or outcome is more desirable with respect to the particular facet or parameter as compared to an alternative process, or a process that is performed without deliberate consideration for the particular facet or parameter.

As used herein, a client device, a driver device, and/or a computing device refer to devices corresponding to desktop computers, cellular devices or smartphones, personal digital assistants (PDAs), laptop computers, tablet devices, television (IP Television), etc., that can provide network connectivity and processing resources for communicating with the system over a network. A driver device can also correspond to a vehicle computing system, or custom hardware, etc. The client device and/or the driver device can also operate a designated application configured to communicate with the intelligent dispatch system.

Still further, while some examples described herein relate to transport services, the system can enable other on-demand location-based services (for example, a food truck service, a delivery service, an entertainment service) to be arranged between individuals and service providers. For example, a user can request an on-demand service, such as a delivery service (e.g., food delivery, messenger service, food truck service, or product shipping) or an entertainment service (e.g., mariachi band, string quartet) using the intelligent dispatch system, and the system can select a service provider, such as a driver, food provider, band, etc., to provide the on-demand service for the user.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

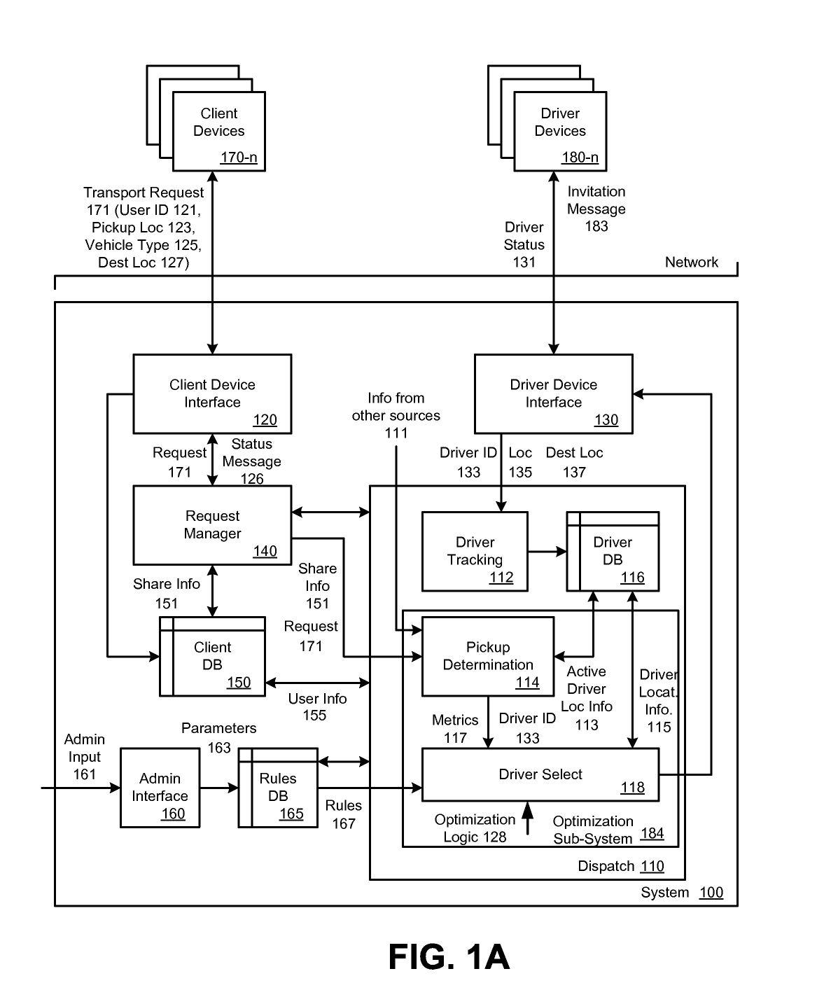

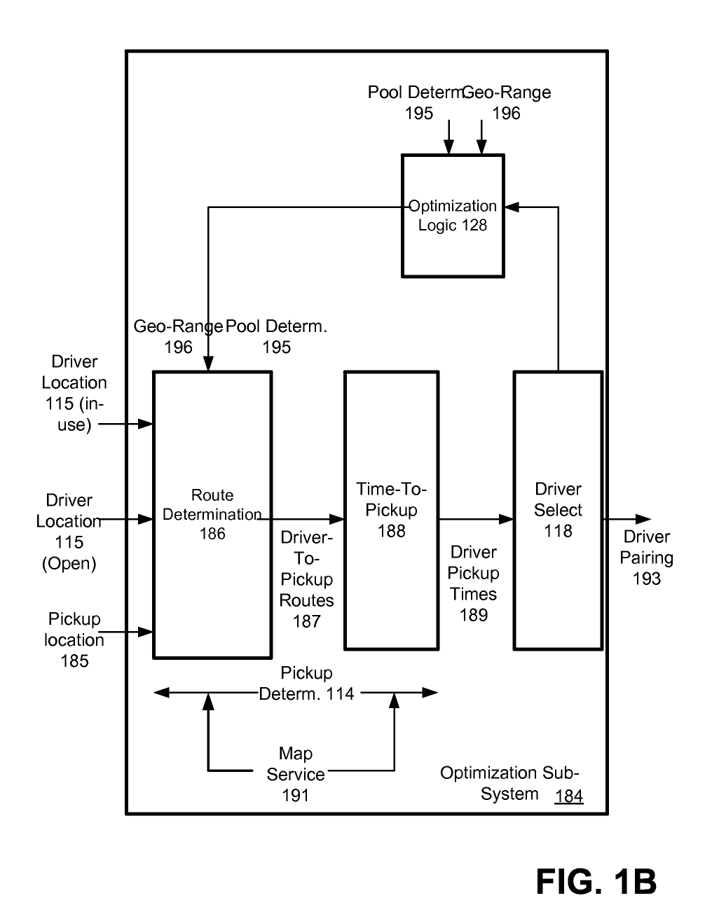

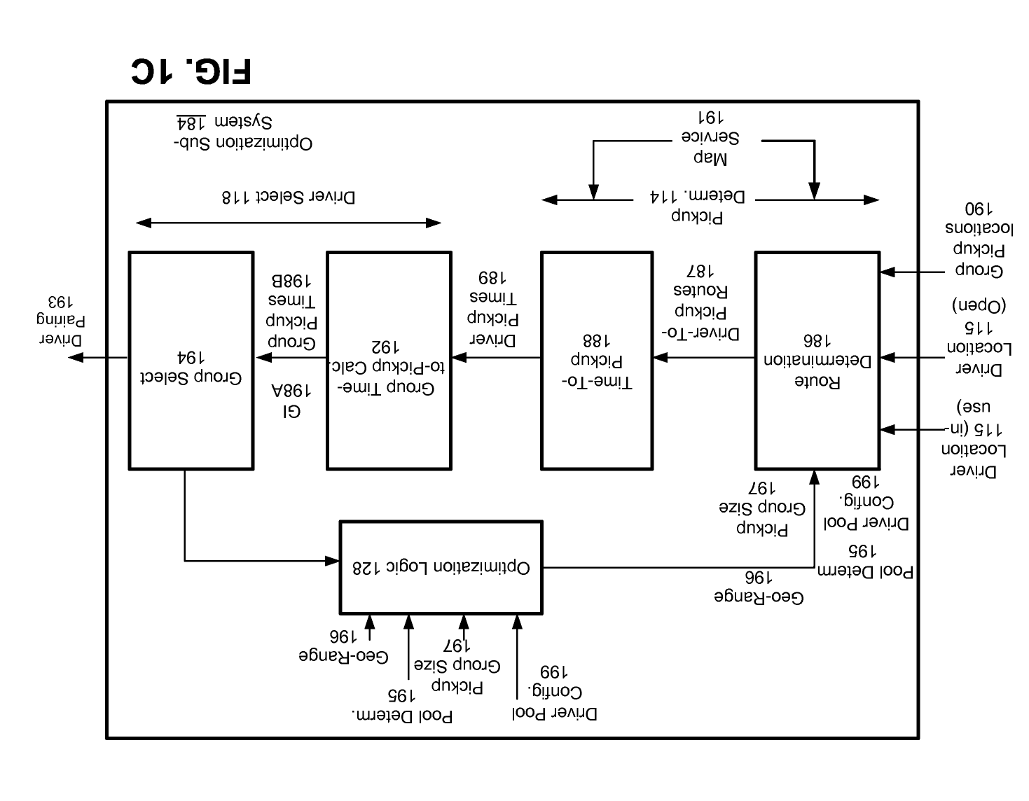

FIG. 1A illustrates an example dispatch system for arranging on-demand transport services, under an example. According to some examples, a system 100 can be implemented to receive transport requests from computing devices that operate to communicate transport requests and corresponding pickup locations. In some examples, the system 100 can be implemented to receive and process a transport request from a computing device of a user for purpose of arranging transport for a user of the computing device. While numerous examples are described in reference to the system 100 for providing vehicle transport services to passengers, the type of transport services provided with various examples can extend to any service in which a person or object is to be transported from a pickup location to a destination. In one implementation, the system 100 determines a pool of drivers for one or more transport requests based, at least in part, on a pickup location specified by a user. The system 100 also determines a driver pool based on a service state of individual drivers, as well as the position information of the individual drivers (e.g., current location, destination location). As described in greater detail, the system 100 responds to individual transport requests by using the service state and location information of drivers of the driver pool to select a driver for a transport request.

According to an example, the system 100 includes a dispatch 110, a client device interface 120, a driver device interface 130, a request manager 140, and an administrator interface 160. The system 100 also includes a plurality of databases for storing records and information, including at least a client database 150, a rules database 165, and a driver database 116. A plurality of client devices 170 and a plurality of driver devices 180 can communicate with system 100 over one or more networks using, for example, respective designated service applications (e.g., configured to communicate with system 100). The components of the system 100 combine to (i) receive transport requests 171 from client devices 170, and (ii) optimize selection of drivers for the transport requests 171. The optimization of the transport requests can be for either individual transport requests or for groups (e.g., two or more) transport requests at once. Logic can be implemented with various applications (e.g., software) and/or with hardware of a computer system that implements the system 100.

Depending on implementation, one or more components of the system 100 can be implemented on network side resources, such as on one or more servers. The system 100 can also be implemented through other computer systems in alternative architectures (e.g., peer-to-peer networks, etc.). As an addition or an alternative, some or all of the components of the system 100 can be implemented on client devices, such as through applications that operate on the client devices 170 and/or the driver devices 180. For example, a client application, such as a service application, can execute to perform one or more of the processes described by the various components of the system 100. The system 100 can communicate over a network, via a network interface (e.g., wirelessly or using a wire), to communicate with the one or more client devices 170 and the one or more driver devices 180.

The system 100 can communicate, over one or more networks, with client devices 170 and driver devices 180 using a client device interface 120 and a device interface 130, respectively. The device interfaces 120, 130 can each manage communications between system 100 and the respective computing devices 170, 180. In some examples described herein, the client devices 170 and the driver devices 180 can each operate a service application that can interface with the device interfaces 120, 130, respectively, to communicate with system 100. According to some examples, the applications can include or use an application programming interface (API), such as an externally facing API, to communicate data with the device interfaces 120, 130. The externally facing API can provide access to system 100 via secure access channels over the network through any number of methods, such as web-based forms, programmatic access via restful APIs, Simple Object Access Protocol (SOAP), remote procedure call (RPC), scripting access, etc.

In examples described herein, the client devices 170 execute corresponding service applications when generating corresponding transport requests 171. In one implementation, transport requests 171 can be automatically generated in response to corresponding users providing input (e.g., in response to user selection of a user interface feature provided from execution of the application) when, for example, requesting transport from a pickup location. In one example, a transport request 171 from an individual user can specify a user identifier (ID) 121 and a pickup location 123. In some variations, the transport request 171 specifies a vehicle type 125 (or alternatively, a service type), and/or a destination location 127. The pickup location 123 can correspond to, for example, the current location of the client device 170 (e.g., as a default setting), a future location of client device 170 and/or a location specified by manual input from a user of the client device 170. For example, the client devices 170 can receive user input that corresponds to a request for transport. The service applications of the client devices 170 can utilize geo-aware resources, such as provided through a Global Positioning System (“GPS”) component of the individual devices, in order to automatically determine the current location of the respective client device 170 as the pickup location. As a variation, the user can provide input corresponding to an address, street intersection, or name of a place (e.g., store, restaurant, building, park, a place of interest, etc.). Still further, a user of client device 170 can use the geo-aware resources of the respective client devices 170 in order to specify a pickup location that is not the current location of the device, but a map location specified by the user. For example, the user can move a selectable feature that is displayed on a map in order to programmatically generate the pickup location 123.

In an example of FIG. 1A, the system 100 receives transport requests 171 from client devices 170. The transport requests 171 can be communicated to the system 100 over one or more networks (e.g., over a cellular network) via the client device interface 120. In one example, the request manager 140 can process individual transport requests 171 by updating and storing information about the transport request 171 in the client database 150, with reference to the requesting user. For example, each transport request 171 can be associated with a corresponding user ID 121. The request manager 140 can manage the transaction for a requesting user by, for example, (i) communicating with the dispatch 110 to determine the status of drivers, (ii) providing communications to the client device 170 regarding the status of the requested transport service, (iii) determining whether the transport service has been completed and whether, (iv) communicating with the financial entities for payment for the user, and (v) maintaining and updating client information for the user in the client database 150.

In one example, the request manager 140 can handle and forward individual transport requests 171 (or relevant information from the transport request 171, such as the pickup location 123, vehicle type 125, and/or destination location 127) to the dispatch 110, such as to the pickup determination component 114 of the dispatch 110. In one example, the pickup determination component 114 can determine a pool (or plurality of drivers) that are candidates for providing transport for the requesting user. The pickup determination component 114 can determine which drivers are candidates for providing transport for the user by performing calculations to determine metrics relating one or more transport requests 171 based at least in part on the corresponding user's pickup location 123, as well as location and other information about the candidate drivers. The active driver location information 113 can be retrieved from the driver database 116.

More specifically, in some variations, information about the drivers can be stored in the driver database 116. The driver tracking 112 can receive driver service state information 131 from the plurality of driver devices 180 via the driver device interface 130. For example, the driver service state 131 can specify the service state of an individual driver. According to some variations, the service state 131 of the individual drivers can include (i) an open state, when the driver is active and available, and not assigned to any transport request, (ii) an occupied state, where the driver is assigned to a transport request, and/or (iii) a tentative assignment state, where the driver is assigned to a transport request and the assignment satisfies a condition of recency or other condition. As described with some examples, some variations account for drivers of the driver pool to have varying service states 131.

The service state 131 can be determined from system 100 tracking assignments, routes and availability of the respective drivers. The driver devices 180 can also provide location information about the driver along with a driver's identifier (ID) 133, the current location 135 of the driver (which can be determined by a GPS component of the driver's device 180) and/or the destination location 137 of the driver. The driver tracking 112 can update the driver database 116 with the driver information in real-time for each respective driver (using the driver IDs 133). In this manner, the dispatch 110 can continuously (or periodically) monitor the current location 115 and service state 131 of drivers of system 100.

According to examples, the selection of drivers for transport request can be optimized as to the amount of time needed for the driver to arrive at a pickup location specified by a given transport request (also referred to as “time to pick up”). For example, based on the pickup location 123 of the requesting user, the pickup determination component 114 can determine, from possible authorized drivers, for example, a pool or plurality of drivers that are capable of providing transport for a given transport request.

In some examples, the pickup determination component 114 accesses the driver database 116 to determine a first set of drivers that are active (e.g., on duty) and available (e.g., not currently driving a customer to a destination and/or not currently driving to a particular customer for pickup). In variations, this determination (output of pickup determination component 114) can be made on a group level for multiple transport requests that are generated from a given geographic region.

In one implementation, the pickup determination component 114 can access the driver database 116 to identify drivers that are within a predefined distance of the pickup location 123, within an estimated travel time (based on an estimated predicted route) of the pickup location 123, and/or within a predefined region of the pickup location 123 based on the current location information 113 of the drivers. For example, the predefined distance (such as ten miles, fifteen miles, etc.), the estimated travel time (such as in minutes, etc.), or predefined region (such as an area of a town or city, or customized and configured geographic region) can be specified by an administrator of system 100 (e.g., via administrator input 161 provided to system 100 using an administrator interface 160). The pickup determination component 114 can calculate or determine, for example, for each authorized driver, the distance between a given pickup location 123, and the current location 113 of that driver and compare the distance with the predefined distance. As an addition or an alternative, the dispatch 110 can include a plurality of driver databases 116 that are each specified for drivers that operate in a particular geographic area (e.g., per metropolitan region, per city, per state, etc.). Based on the region in which the pickup location(s) 123 is/are located in, the pickup determination component 114 can (i) determine authorized drivers having a current location in that region to be within the predefined distance or region of the respective pickup location 123, or alternatively, (ii) calculate, for example, for each authorized driver in that region, the distance between the pickup location 123 and the current location 113 of that driver and compare the distance with the predefined distance.

The pickup determination component 114 can filter out drivers from a larger pool of drivers that are not within the predefined distance or region of the pickup location 123, e.g., filter out drivers that are classified or determined as being too far from the user's pickup location 123. The pickup determination component 114 can also access the driver database 116 to determine, from the drivers that are within the predefined distance, the estimated travel time, or region of the pickup location 123, those drivers that have service states 131 (e.g., open drivers) which make them candidates for providing transport for the open transport requests. As described with some examples, drivers with different service states (e.g., occupied, tentatively assigned) can be deemed available for a given transport request when the drivers of the respective service states have location or status which satisfies one or more conditions that are specific to the particular service state. For example, drivers with the service state of occupied can be considered available for transport requests in a given geographic region if the time or distance to destination for those drivers at a particular moment is less than a threshold. Likewise, drivers with the service state of on route (or tentative pickup assignment) can be considered available for transport request(s) if the driver's pickup selection satisfies some criteria, such as the pickup assignment having a lifespan that is less than a given threshold of time (e.g., less than two minutes since assignment of driver was tentatively made). The drivers that satisfy such conditions (which can vary, depending on implementation and service states that are considered) can be identified as candidates for providing transport service to individual transport requests.

By way of another example, the pickup determination component 114 can identify candidate drivers as those that (i) are in-use, (ii) are within a predefined distance of the pickup location 123 and/or within a predefined region of the pickup location 123 based on the current location information 113 of the drivers (such as described above), and (iii) are providing transport for another transport request, where the destination location is within a threshold distance or estimated travel time from the pickup location 123 of the requesting user. In this manner, the dispatch 110 can determine that an in-use driver (that is currently providing transport service for another customer) can be a possible candidate driver for providing service for the requesting user if the driver's destination (e.g., the drop off location for the current customer) is close to or proximate to a given pickup location. In this context, the term “proximity” can be a reference to distance and/or estimated travel time between two reference points.

In examples, the drivers which have an occupied service state 131 can be associated with a destination location 137 (i.e., where a fare of the occupied driver is likely to end). The destination location 137 can be entered manually by, for example, either the user that requested the transport (e.g., the passenger) or the driver with the occupied state. In variations, the destination location 137 can be determined through programmatic analysis, such as through historical analysis of where a given passenger of the driver with the in-use state has previously been dropped off. In variations, the pickup determination component 114 can estimate or predict the destination location, or a region in which the destination location is estimated to be located in, based on at least one of (i) current travel direction of the in-use driver, (ii) previous pickup and destination locations of the requesting user, (iii) frequent destination locations of the user that is being transported by the driver, or (iv) other factors, such as time of day, event calendars in a geographic region or city, etc.

In one example, for each in-use driver having an occupied service state 131 and a current (or future estimated) location within a predefined distance of the current pickup location 123, the pickup determination component 114 can determine (i) a distance from that driver's respective destination location to the pickup location 123 of the requesting user, and/or (ii) a first estimated travel time from that driver's respective destination location to the pickup location 123 of the requesting user. Depending on implementation, the pickup determination component 114 can use information 111 from other sources to predict the estimated travel times (e.g., from other external/remote databases or sources, or from other databases of system 100, not shown in FIG. 1A). For example, for each driver having an occupied service state 131, the pickup determination component 114 determines the distance and/or estimated travel time from that driver's respective destination location to the pickup location 123 by predicting or determining a most likely route the driver would take to get from the respective destination location to the pickup location 123.

In addition, the estimated travel time and the most likely route can be determined based on a number of different factors, such as, for example (i) historical information of the driver with respect to previously routes driven (which can be stored in a driver database 116 and/or a historical database), (ii) current traffic conditions, (iii) the date and/or time of day (e.g., morning, afternoon, late night, rush hour time, etc.), (iv) current weather conditions, (v) mapping information from a map database (e.g., what type of roadways are nearby, tunnels, bridges, one way streets, etc.), (vi) the current location 113 of the driver and the pickup location 123 (e.g., what neighborhoods the locations are in), and other information (e.g., street speed limits, train schedules, city event calendars, construction zones, etc.). Such information can be received or retrieved from other sources (e.g., information 111). For example, the pickup determination component 114 can determine the estimated travel time from point A (the destination location of an in-use driver) to point B (pickup location 123 of the requesting user) at 7 pm on a weekday when it is currently raining in San Francisco, Calif., to be longer than the estimated travel time for the same points A and B on a Saturday at 10 am on a sunny day.

For the driver with the occupied service state 131, if the determined distance and/or estimated travel time from the destination location to the pickup location 123 is within a threshold distance and/or threshold estimated travel time, the pickup determination component 114 can identify that driver as being a candidate for providing transport to a particular transport request or grouping of transport requests. The threshold distance and/or the threshold estimated travel time can also be configured by an administrator of system 100 via the administrator interface 160.

For the driver with the tentatively assigned service state 131, the driver tracking 112 can monitor, via the driver device interface 130, time or distance from when the particular driver was assigned a transport request. If the time or distance from when the driver was assigned a transport request is less than the threshold, then their particular driver can also be deemed as a candidate for a transport request or group of transport requests.

In some examples, the transport requests 171 can request or otherwise be specific to a vehicle type 125 (e.g., sedan, SUV, limousine, hybrid, non-black sedan car, etc.). In such examples, the pickup determination component 114 can determine possible authorized drivers from the driver database 116 having the corresponding vehicle type 125. From the drivers having the corresponding vehicle type 125, the pickup determination component 114 can determine a group of drivers that are capable of providing transport for the requesting user (e.g., including a first set of drivers that are active and available, and a second set of in-use drivers (e.g., those that have an occupied service state) that satisfy the distance and/or estimated travel time thresholds, as discussed).

According to some examples, an optimization subsystem 184 can be provided with the dispatch 110 in order to optimize the selection of drivers by optimizing the time to pick up for individual transport requests. As described in greater detail, the optimization subsystem 184 can include logical components and processes that collectively operate to utilize distance and time measurements as between available drivers and individual transport requests. In an example of FIG. 1A, the optimization subsystem 184 includes the pickup determination component 114, a driver selection component (“driver select 118”), optimization logic 128 and/or a rule set (e.g., rules database 165). After the pickup determination component 114 identifies the plurality of drivers that are capable of providing transport for the requesting user (including the first set and the second set of drivers), the pickup determination component 114 can provide metrics 117 (e.g., the current location information 115 of the driver, the determined distance and/or estimated travel time information, the service state 131 of the driver) as well as the corresponding driver IDs 133 to the driver select 118. The driver select 118 can implement optimization logic 128 in order to select drivers for transport requests based on an optimization objective and associated criteria. According to some examples, the optimization sub-system 184 can optimize the selection of drivers to transport requests based on an estimated time to pick up. Depending on implementation, the optimization sub-system 184 can optimize the selection of drivers for transport requests on a singular or individual transport request basis. In variations, the optimization sub-system 184 can also optimize the selection of drivers for transport requests on a group basis. When selecting a driver for a transport request, the driver select 118 uses the pickup location 123 of a pickup request (e.g., singular transport request optimization), or of each of multiple transport requests (e.g., group transport request optimization). For each pickup location 123, the driver select 118 uses the metrics 117 to select a driver for that transport request. The driver select 118 can also receive location information 115 about active drivers from the driver database 116 and information about the requesting user 155 from the client database 150 for purposes of driver selection.

In some examples, the driver select 118 can perform a driver selection process based on a determination as to the lowest estimated time to pick up from amongst a set of candidate drivers for a particular transport request. In variations, the driver select 118 can implement optimization on a group basis, in accordance with an objective to optimize the time to pick up for a group of transport requests. In making the determination, the driver select 118 can implement optimization logic 128, which can provide a process or rule-based approach for optimizing the time to pick up for individual transport requests. For example, the optimization logic 128 can implement a recursive process to determine optimal time to pick up for one or multiple transport requests based on variations to the distance range from which candidate drivers can be identified, the available service states to use for consideration, and/or a time to wait before making driver selection.

As an addition or variation, the driver select 118 can utilize one or more rules 167 for selecting drivers for individual transports. The rules 167 can further define optimization, or alternatively provide a limit, constraint, or filter on the determination of the driver. In one implementation, the rules 167 can be predetermined and provided in a rules database 165. In some variations, the rules can be parameterized and/or weighted based on outcomes of optimization logic 128. Still further, in some variations, an administrator of the system 100 can access the administrator interface 160 to provide input 161 corresponding to operational parameters 163. These parameters 163 can be stored in the rules database 165 as rules 167 that the dispatch 110 can use to (i) determine which drivers are capable or qualified to provide transport service for the requesting user, and (ii) select a driver, from the plurality of identified drivers, for the requesting user. For example, the parameters 163 can configure the optimization logic 128 for driver selection.

For example, the rules database 165 can store information about the predefined distance or region information used by the pickup determination component 114 to determine the plurality of drivers that are close enough to provide transport service for the user (e.g., those drivers that are within the predefined distance or predefined region from the pickup location 123 of the requesting user). The rules database 165 can also provide threshold distance and threshold estimated travel times that the pickup determination component 114 uses in determining whether a particular in-use driver is capable of providing transport service for the requesting user. The values provided with each of these parameters can be varied in accordance with the optimization objectives (e.g., reducing time to pick up for individual transport requests, reducing an aggregation of the time to pick up for each transport request of the group). For example, as specified by one or more rules 167, if the total estimated travel time of an in-use driver (which includes a sum of the estimated travel time from the current location 135 of an in-use driver to the destination location 137, and the estimated travel time from the destination location 137 to the pickup location 123 of the requesting user) is equal to or greater than the threshold estimated travel time, then the pickup determination component 114 does not include that in-use driver as part of the pool of drivers that are capable of providing transport service for the user.

Still further, one or more rules 167 can also specify dynamically adjusting the dispatch radius (e.g., the threshold distance and/or threshold estimated travel time) for individual authorized drivers based on the current location 135 of the respective drivers and the pickup location 123 of the transport request(s). Different drivers can be associated with different dispatch radiuses for determining whether that driver is a candidate (e.g., based on driver state and/or location) for providing transport for a user. For example, a driver A and a driver B can both be in San Francisco and within the predefined distance or predefined region of the pickup location 123, a street intersection in San Francisco. However, driver A can have a threshold distance (e.g., two miles) that is smaller than the threshold distance of a driver B (e.g., four miles) based on the current locations of each of driver A and driver B and/or the pickup location 123 of the user. Driver A, for example, can be in a highly congested downtown area of San Francisco with a high amount of intersections and traffic lights, whereas driver B can be in a region that is less congested and/or has higher speed limits or less traffic lights. Similarly, a driver that is currently in the suburbs or on a fast moving traffic freeway, for example, can have his or her dispatch radius be increased (as compared to his or her dispatch radius when that driver is in the city). When the dispatch radius is increased, the driver has a higher probability to be deemed capable of providing transport for a requesting user.

As an addition or an alternative, the dispatch radius for a particular driver or groups of drivers can be set to zero, for example, to black out a particular driver or drivers (e.g., prevent the driver from picking up users). A plurality of drivers that are in a particular geographic region, such as a pre-configured region specified by three or more points on a map (e.g., inputted by an administrator using the administrator interface 160), can each have a dispatch radius dynamically adjusted to zero so that drivers cannot be dispatched when they are in the particular region.

In other examples, the rules database 165 can store rules 167 that the driver select 118 can use to select a driver, from the capable drivers, for the requesting user. According to some examples, the rules 167 can specify how the driver select 118 can prioritize or rank the drivers, and select the highest prioritized or ranked driver. For example, the prioritization or ranking can be used by the dispatch 110 so that if a first selected driver does not accept an invitation for providing the transport service, the next ranked or prioritized driver is selected and invited to provide the transport service, and so forth. The rules 167 can specify prioritizing capable drivers based on one or more of (i) an active driver's distance from her current location 113 to the pickup location 123 of the requesting user, (ii) an active driver's estimated travel time from her current location 113 to the pickup location 123, (iii) an in-use driver's total distance from her current location 113 to the pickup location 123 (the sum of a first distance from her current location 113 to the respective destination location and a second distance from the destination location to the pickup location 123), and/or (iv) an in-use driver's total estimated travel time from her current location 113 to the pickup location 123 (the sum of a first travel time from the respective destination location to the pickup location 123 and a second travel time from her current location 113 to the respective destination location). In one example, the rules 167 can specify that the capable drivers are ranked based on total distance so that shortest distance is prioritized over longer distance or based on total estimated travel time so that shortest estimated travel time is prioritized over longer estimated travel times.

In addition, the rules 167 can also specify prioritizing capable drivers based on one or more of (i) feedback information of a driver (e.g., drivers' ratings), (ii) feedback information of the requesting user, (iii) whether any of the capable drivers have previously provided transport service for the requesting user (e.g., select or prioritize a previously used driver over other capable drivers if the requesting user gave that previously used driver good feedback), (iv) driver preferences, (v) user preferences, (vi) personal information about the driver (e.g., gender, age, etc.), (vii) personal information about the user (e.g., from the client database 150), (viii) the age of the driver's vehicle (e.g., prioritize newer vehicles over older vehicles), and other factors. Any combination of the discussed factors can be used by the driver select 118 to prioritize the determined drivers capable of providing transport for the user and selecting a driver for that user. For example, in one implementation, the rules 167 can enable different weights to be applied different factors for purposes of prioritizing the capable drivers.

As an example, the pickup determination component 114 determines five drivers (D1, D2, D3, D4, and D5) that are capable of providing transport for a user who requested transport with a pickup location 123 in San Francisco, Calif. D1 and D2 can be active drivers that are available, while D3, D4, and D5 can be in-use drivers that are driving to respective destinations. Based on the different configured rules 167, in one example, the pickup determination component 114 can rank or prioritize the drivers based on shortest estimated travel time from the respective current locations to the pickup location 123, such as D3 (four minutes), D2 (five minutes), D4 (eight minutes), D1 (ten minutes), and D5 (eleven minutes), and select D3 for having the shortest estimated travel time for picking up the user. In another example, the pickup determination component 114 can determine that D2 has previously provided transport service for the user and that the user has indicated a positive feedback or rating for D2 (e.g., five stars out of five stars). The pickup determination component 114 can prioritize D2 over D3 and/or select D2 instead of D3 (even though D3 has a shorter estimated travel time) provided that the estimated travel time of D2 is not significantly (e.g., within a threshold time difference) longer than the estimated travel time of D3. According to other examples, based on the rules 167, the pickup determination component 114 can prioritize the drivers based on any one of a combination of distance, estimated travel time, the status of the driver (e.g., whether the driver is available or in-use), vehicle type, the age of the vehicle, user/driver preferences, etc. For example, a combination of estimated travel time (and/or distance) and the age of the vehicle (e.g., newer vehicles can be prioritized ahead of older vehicles with substantially similar estimated travel times) can be used for prioritizing capable drivers.

In response to selecting a driver, the dispatch 110 can transmit an invitation message 183 to a corresponding driver device 180 of the selected driver (e.g., using the driver ID 133) via the driver device interface 130. The invitation message 183 can be viewed as part of an interface of a service application running on the driver device 180. The invitation message 183 can include information about the requesting user, the pickup location of the user, and provide selectable features to enable the driver to accept the transport service or reject/decline the transport service. For example, while a driver is already driving another customer to a respective destination, the driver can receive an invitation message 183 that the driver can accept even before dropping off the other customer. If the driver declines the transport service, the dispatch 110 receives the rejection and the driver select 118 selects another driver for the requesting user. In one example, the driver select 118 can continue to select a driver each time a rejection is received until there are no more capable drivers available. When no drivers are available, the dispatch 110 can notify the request manager 140 of an error or that no drivers are available so that the request manager 140 can provide a status message 126 to the client device 170 of the requesting user to notify that user of the failure to arrange a transport.

If the driver accepts the transport service, the dispatch 110 can provide information about the driver to the request manager 140 (or the driver's ID 133 so that the request manager 140 can retrieve necessary driver information from the driver database 116). The request manager 140 can notify the requesting user by transmitting a status message 126 via the client device interface 120 to the client device 170 of the requesting user that a driver has been selected. The status message 126 can include information, such as information about the driver (e.g., an image and name of the driver, vehicle license plate number) and information about the transport service (e.g., estimated time of arrival). The request manager 140 can manage the transaction for the requesting user, and when the transport service has been completed, arrange for payment and update client information for the user in the client database 150 (e.g., log the trip, generate a receipt).

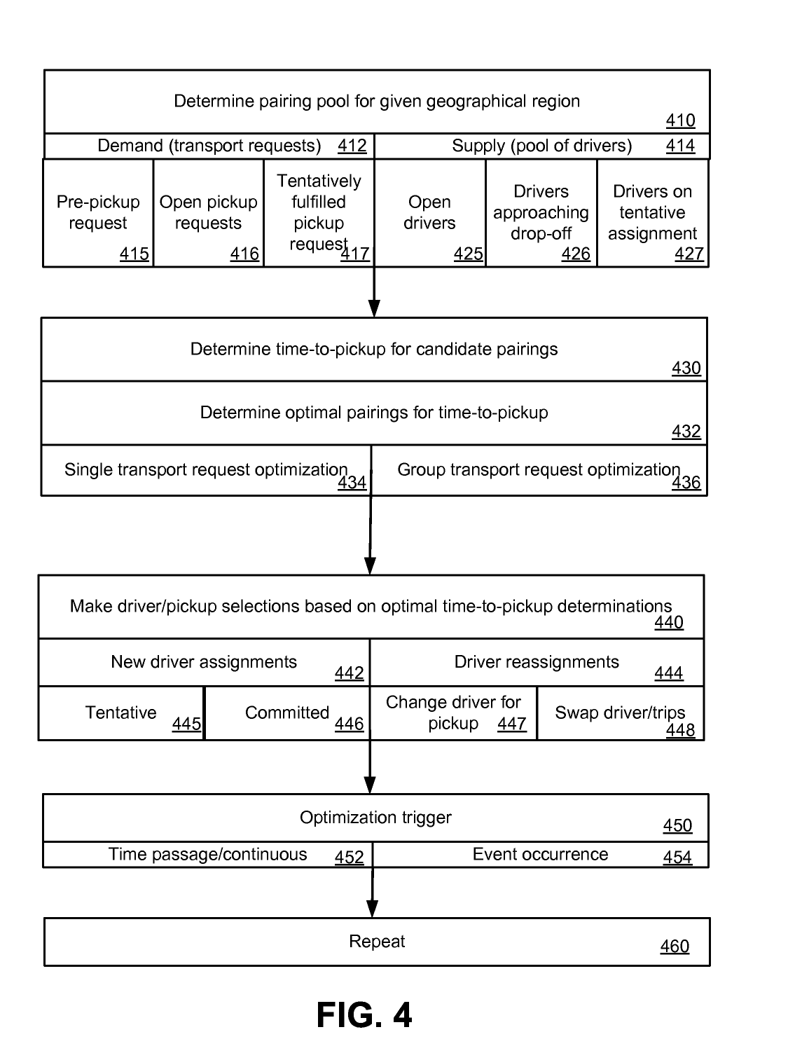

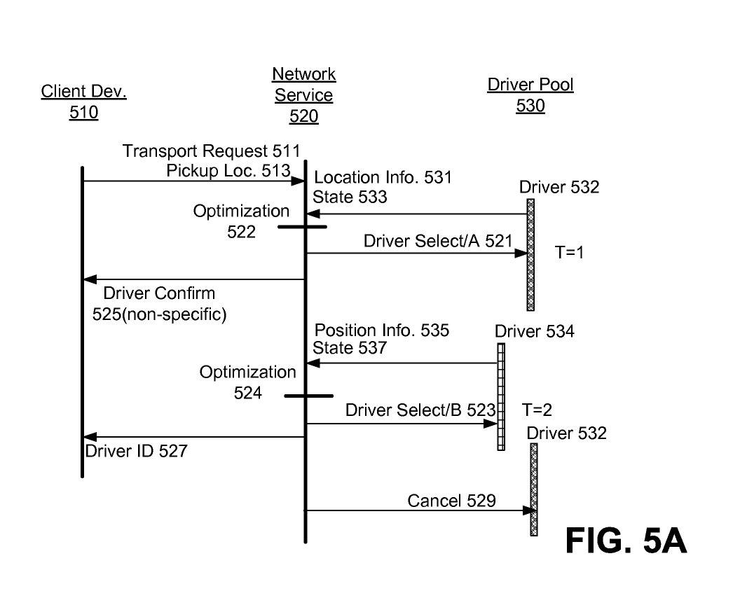

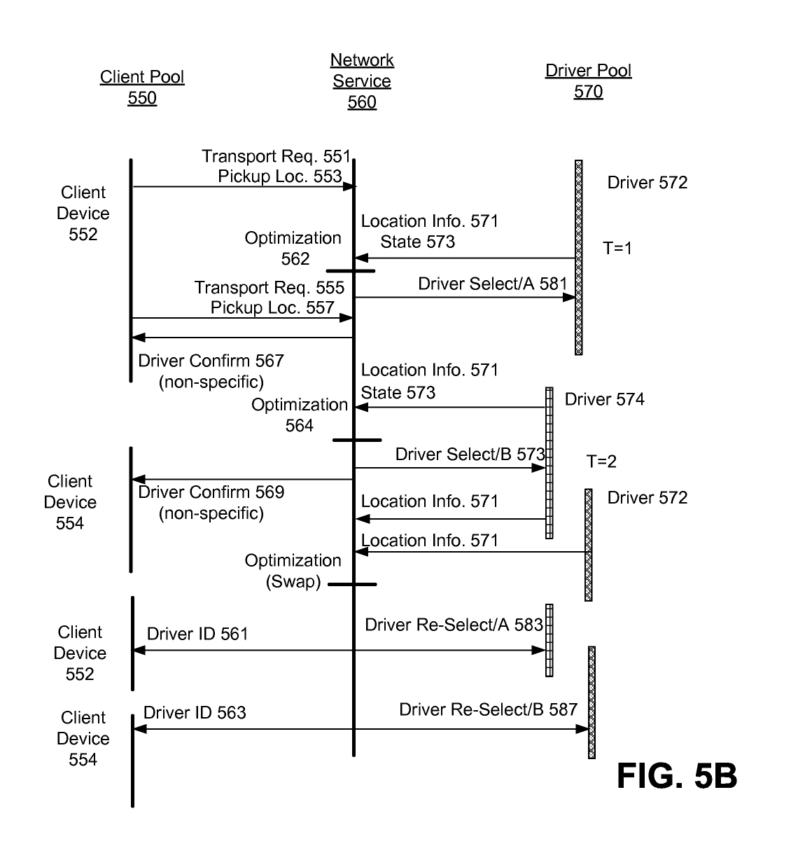

In this manner, the dispatch 110 can intelligently select a driver for providing transport for a user even when the driver's service state 131 is in-use or assigned. The determination of when to assign such drivers can be determined from implementation of the optimization logic 128, which can implement an objective to reduce the time to pick up for either a single transport request or for multiple transport requests. These and other examples for implementing optimization for reducing time to pick up are further described with examples of FIG. 1B, FIG. 1C, FIG. 4, and FIG. 5A and FIG. 5B.

### Multi-Party Ride Sharing

According to some examples, the pickup determination component 114 can also determine a third set of drivers (“ride sharing driver set”) as candidates for providing transport for a given transport request (e.g., in addition to the first set of drivers and the second set of drivers, as discussed). More specifically, according to some examples, a ride sharing driver set of drivers can include drivers that are currently in-use, but are also deemed to be capable of providing transport for the requesting user based on (i) the respective current location of a driver during travel to drop off a current customer, (ii) the respective destination of the driver (e.g., the destination of the current customer), (iii) the pickup location of the user, and (iv) the respective destination of the user.

For example, the pickup determination component 114 can access the driver database 116 to identify drivers that (i) are in-use, (ii) have respective current locations 113 that are within a first threshold distance and/or first threshold estimated travel time of the pickup location 123, and (iii) have respective destination locations 137 that is within a second threshold distance and/or second threshold estimated travel time from the destination location 127 of the requesting user. In this manner, a driver that is currently taking a customer to a destination can be categorized as being capable of providing transport for a requesting user if that driver is close enough to the pickup location of the requesting user and if the two destination locations are relatively close to each other. The dispatch 110 can assume that the general direction of travel and destination for both the customer and the requesting user is close enough so that the customer and the requesting user would agree to share the ride and split the fare. For example, the first threshold distance or estimated travel time is used so that an in-use driver (and current customer) would not have to go far and out of the way to pick up a requesting user for ride sharing, while the second threshold distance or estimated travel time is used so that the in-use driver does not have to take the current customer and the requested user (once he or she is picked up) to two different locations or directions that are far from each other. The pickup determination component 114 can include these drivers (as a third set of ride-sharing drivers) in the pool or plurality of drivers capable of providing transport to the requesting user.

In such examples, the requesting user can provide an input (e.g., using an interface of the application running on the client device 170) to (i) select an option that he or she is willing to share a ride or not share a ride when the requesting user makes the transport request 171 (e.g., by selecting a “ride share” vehicle type 125), or (ii) specify in the user's profile that he or she is willing to share a ride or not share a ride. For example, the user can operate the client device 170 to provide input to update the user's profile (e.g., account information, payment information, ride sharing information), and system 100 can update the client's profile in the client database 150. When the user makes a transport request 171, the request manager 140 can access the profile of the user to determine the share info 151 (e.g., whether the requesting user is willing to share a ride) and/or receive the share info 151 as part of the transport request 171. Similarly, an existing customer that is being provided transport by an in-use driver, can have also specified, when the request was previously made, a “ride share” vehicle type 125, or can have specified in his or her profile with share info 151.

In this manner, for a requesting user that is willing to share a ride, the pickup determination component 114 can determine a set of ride sharing drivers (e.g., in addition to the first set of active drivers and the second set of in-use drivers, as discussed above) that satisfy the one or more conditions (based on the rules 167)—e.g., drivers that (i) are in-use (and/or have provided input that there is at least one available seat in the vehicle, e.g., has a vacancy), (ii) have respective current locations 113 that are within a first threshold distance and/or first threshold estimated travel time of the pickup location 123, and (iii) have respective destination locations 137 that is within a second threshold distance and/or second threshold estimated travel time from the destination location 127 of the requesting user. In addition, in one example, for each of the ride-sharing drivers, the respective customer(s) that are being transported should have corresponding share info 151 that indicates that he or she is willing to share a ride with other users.

As discussed above, once the pickup determination component 114 determines the plurality of drivers that are capable of providing transport to the requesting user, the driver select 118 can prioritize or rank the capable drivers and select a driver for the requesting user. Using one or more rules 167 that specify the prioritization and/or selection of drivers, the driver select 118 can select a first driver and the dispatch 110 can transmit an invitation message 183 to the driver device 180 of the first driver. For example, in one example, the driver select 118 can use the distance or estimated travel time metrics 117 and the status of the driver (e.g., whether the driver is in the first set, second set, or third set) to prioritize the capable drivers. Those drivers of the ride sharing set can be prioritized higher than drivers in the first or second set, so that the transport service can be cheaper for a requesting user (e.g., as a result of splitting the fare). Other factors and rules 167 can be used by the driver select 118 to prioritize the drivers and select a driver.

In one example, a selected driver, such as a driver in the third set, can receive an invitation message 183 and determine whether or not she wants to accept the transport request. The invitation message 183 can include information about the requesting user and the pickup location of the user, so that the driver can make the final decision whether or not to pick up the user (e.g., the driver may not want to pick up the user if she determines that the user is too far or the destination is out of the way). If the driver accepts the request, the request manager 140 receives that information and provides a notification to the client device 170 of the requesting user. In another example, the driver may have previously specified (when logging on as being on-duty) a vehicle type. Such a vehicle type may correspond to a “ride share” vehicle type. When the driver specifies such a vehicle type to permit picking up of multiple requesting users, the invitation message 183 can be automatically accepted by the driver service application (e.g., as the driver had agreed to provide ride share services).

According to an example, when a driver of the ride sharing set accepts the request, the fare from the time the dispatch is accepted to the time that one of the current customer or the requesting user is dropped off at a destination location can be split evenly between the customer and requesting user. This may provide incentive for the current customer who is being driven out of the way to pick up the requesting user. In addition, when another user makes a request, the same in-use driver may be a candidate for providing transport for the subsequent user despite having two current users in the vehicle going to two different destinations. Similarly, the fare can be split between the ride-sharing users based on when the dispatch is accepted by the in-use driver.

In this manner, when a user makes a transport request, the dispatch system can optimize the selection of a driver for that user based, at least in part, on the location information provided by the user (pickup and/or destination location) and the current status and/or location information of the drivers. Drivers that are currently providing transport to other users can be identified as a candidate driver for a requesting user despite not having completed the transport.

### Optimization Sub-System for Single or Group Objective

FIG. 1B illustrates a first implementation of an optimization sub-system 184 for selecting a driver of a transport request in a manner that optimizes the time to pick up for that transport request, according to an example. FIG. 1C illustrates a second implementation of an optimization sub-system 184 for selecting a driver of a transport request in a manner that collectively optimizes the time to pick up for a group of transport request, according to an example.

With reference to FIG. 1B, the optimization subsystem 184 includes pickup route determination 186, time to pick up determination 188, and the driver select 118 (e.g., such as described in FIG. 1A). The pickup route determination 186 and time to pick up determination 188 can be implemented by the pickup determination component 114 of an example of FIG. 1A. The route determination 186 receives as input (i) pickup location 185 of a requesting user (e.g., as provided with the request 171), and (ii) driver location information 115. In one implementation, the driver location information 115 includes drivers that have the service state of being open. In variations, the driver location information 115 includes candidate drivers that have the service state of being in-use, including drivers that are near completion of an existing transport and/or drivers that have been newly assigned to a particular transport request (e.g., drivers on route to a pickup location of a transport request).

The pickup route determination 186 calculates routes as between the available or candidate drivers and the pickup location 185. In one implementation, the pickup route determination 186 select routes for each available or candidate driver (“driver-to-pickup route 187”) to the pickup location 185. The driver-to-pickup routes 187 can be based on one or more criteria, including shortest distance, most use of highways, real time traffic reports, and/or other considerations. The time to pick up determination 188 can determine the driver pickup times 189 for each driver based on the driver-to-pickup route 187. A third-party mapping service 191 can be used to determine roadways and/or traffic conditions which can affect both route selection and time-of-travel. In variations, functionality provided with the pickup route determination 186 and/or time to pick up determination 188 can be provided substantially or partially through a third-party mapping service, which can provide, for example, route selection and/or travel times as between two points (e.g., current or anticipated location of driver and pickup location of transport request).

In an example of FIG. 1B, the driver select 118 selects a driver for a transport request by comparing the driver pickup times 189. The determination of the driver pairing 193 can be based on, for example, the smallest driver pickup time 189. In this way, the driver pairing 193 can be optimized for time to pick up.

Certain parameters can affect the number of available or candidate drivers, and thus the time to pick up for the selected driver pairing 193. One such parameter is a time duration during when the pool of available or candidate drivers is determined. The longer the time duration, the more drivers which can be considered for the particular transport request. The time duration for determining the pool of drivers (“pool duration 195”) however, represents a cost of optimization, since if the pool duration 195 is too long, then the eventual time to pick up for a given transport request can be lengthened solely by this parameter. In one implementation, the optimization logic 128 can operate with the driver select 118 in order to adjust or select the pool duration 195 in order to optimize the time to pick up from the selected driver. The optimization logic 128 can, for example, receive the time to pick up for the driver pairing 193 and then compare that time with hypothetical time to pick up for drivers that would have been selected in alternative pool durations. Statistical or learning models can, for example, be used to set the pool duration 195 based on factors such as number of available or candidate drivers, the time of day, the amount of traffic, etc.

Another parameter that can affect the number of available or candidate drivers is a geographical range parameter 196 from which available or candidate drivers are determined. A greater geographic range can increase the number of drivers in the pool from which selection can be made. But if the range is too great, then the likelihood of identifying a suitable driver for a particular transport request becomes smaller. The optimization logic 128 can also expand or contract the geographic range relevant to a particular transport request in order to obtain a suitable driver pool from which the driver pairing 193 can be determined.

Accordingly, in some variations, optimization logic 128 can be implemented to tune or adjust parameters which directly or indirectly can affect the optimization objective for determining driver pairings. In an example of FIG. 1B, the optimization logic 128 can signal or set optimal pool duration 195 and geographic range 196 when determining the inputs for route determination 186 and/or time to pick up determination 188.

With reference to FIG. 1C, the optimization sub-system 184 implements an alternative optimization objective to optimize an aggregation of time to pick up for a group of transport requests. For example, at a peak time and in a given geographic region, m transport requests can be open and unassigned (or unfulfilled) at a given time (e.g., multiple requests can be made around a similar time), and the pool of drivers available can range between r and p, depending on the rules and initial parameters for determining driver availability and candidates (e.g., geographic range, pool duration, service state of drivers that can be candidates, etc.). Examples recognize that when the optimization objective is directed to singular transport requests rather than the group as a whole, the time to pick up for individual transport requests may be optimized, but the time to pick up for the group can become non-optimal. As such, the optimization sub-system 184 can, as an addition or alternative to other examples such as provided with FIG. 1B, can implement an objective to minimize time to pick up for an aggregation of transport requests at any one time.

As with an example of FIG. 1B, the optimization subsystem 184 can include processes of pickup determination component 114 and driver select 118. The pickup determination component 114 can include pickup route determination 186 and time to pick up determination 188, while the driver select 118 includes a group time to pick up calculator 192 and group driver and transport request selection 194 (“group select 194”). An output of the group driver and transport request selection 194 can include multiple driver and transport request pairings 193. The route determination 186 receives as input (i) pickup locations 190, representing pickup locations provided with multiple transport requests 171 (see e.g., FIG. 1A) during a given duration of time, and (ii) driver location information 115. As with other examples, the driver location information 115 can include drivers that have the service state of being open, as well as driver location information 115 for candidate drivers that have the service state of being in-use (e.g., drivers that are near completion of an existing transport and/or drivers that have been newly assigned to a particular transport request).

The pickup route determination 186 calculates routes as between the available or candidate drivers and each of multiple pickup locations 190 representing the group of transport requests. Assuming the available and candidate drivers and the pickup locations are within sufficient proximity, the pickup route determination component can determine a route as between each available or candidate driver and each pickup location. In one implementation, the pickup route determination 186 determines the driver-to-pickup route 187 for each of the multiple pickup locations 190 using, for example, criteria such as most use of highways, real time traffic reports, and/or other considerations. The time to pick up determination 188 can determine the driver pickup times 189 for each driver to each of the multiple pickup locations 190. As with other examples, the third-party mapping service 191 can be used to determine roadways and/or traffic conditions which can affect both route selection and time-of-travel for the routes determined as between each driver and each pickup location. In variations, functionality provided with the pickup route determination 186 and/or time to pick up determination 188 can be provided substantially or partially through the third-party mapping service 191, which can provide, for example, route selection and/or travel times as between two points (e.g., current or anticipated location of driver and one of multiple pickup locations provided with pending transport requests).

In an example, the group time to pick up calculator 192 aggregates the time to pick up for the pickup locations of the group of transport requests to determine an aggregate time to pick up for each possible combination of driver and transport request pairing. The aggregate time to pick up can be based on, for example, every combination of driver and pickup location pairing between each transport request of the group and each available or candidate driver, utilizing an estimated pickup route and/or pickup time for each pickup/driver pairing being provided by, for example, map service 191 and/or the combination of route determination 186 and time to pick up determination 188. An output of the group time to pick up calculator 192 can be represented as grouping identifier (“GI 198A”) and aggregate pickup time for the grouping (“APT 198B”).

From the grouping identifier 198A and the aggregate time to pick up 198B, the group select 194 makes pairings of available or candidate drivers with transport requests, in accordance with an optimization objective (e.g., reduce time to pick up for group as a whole). An output of the group select 194 can include multiple driver and transport request pairings (e.g., a first driver with a first user, a second driver with a second user, etc.). In one implementation, the group select 194 selects the particular grouping having the smallest total aggregate pickup time. Such a selection can be based on, for example, minimizing the average pickup time for each transport request in the group. In a variation, the group select 194 can select a particular grouping representing the smallest median pickup time amongst the group of transport requests. Numerous such variations are possible. For example, the group select 194 can utilize rules to exclude outlier transport requests from the optimization objective, on the rationale that the outlier transport request will wait a relatively long time regardless. Still further, another variation can utilize a hybrid approach, where the group select 194 implements singular optimization for some transport requests and group optimization on the remainder of the transport request. Still further, the group select 194 can implement optimization for a subset of the transport requests in the given duration of time, and rollover other transport request to another grouping for subsequent determination. In this way, the criteria and conditions for determining the particular optimization objective can vary depending on design choice, business considerations, or other factor.

With further reference to an example of FIG. 1C, the optimization logic 128 can be implemented to repeat and continue the optimization process as drivers are continuously assigned to transport requests. In one implementation, even when a group optimization objective is determined, the assignment of drivers to transport requests can be calculated and recalculated based on changes to the number of available or candidate drivers. In running continuously, variations to the optimization logic 128 can expand or contract the respective driver pools using drivers with varying service states, such as on-route (or tentatively assigned) or in-use (completing a trip).

Additionally, as with an example of FIG. 1B, the optimization logic 128 can tune or otherwise select input parameters that can affect the outcome for driver pairings. For example, parameters such as pool duration 195 (e.g., the duration of time in which available or candidate drivers are considered for a particular set of transport requests), and geographic range 196 can affect the constituents of both the driver pool and transport request or pickup pool. The optimization logic 128 can utilize as input, existing values for geographic range 196 and pool duration 195, and run samples of hypothetical group aggregate pickup times over the same duration in order to obtain, for example, statistical or learned models (e.g., time of day, amount of demand or supply, etc.) for determining pool duration 195 and/or group size.

With group pairings, the outcome can also be affected by parameters that set the group size for transport requests 197 (e.g., absolute maximum of transport request or drivers in a particular group, ratio of available or candidate drivers to pickup requests, etc.), as well as for available drivers 199 (e.g., maximum drivers for given group or ratio, service states and thresholds (e.g., in-use drivers that are within x minutes or y miles of destination before becoming open). These parameters can be used, for example, to filter or select the transport requests and candidate or available drivers for optimization and pooling at a given instance or duration.

### Transport Request Optimization

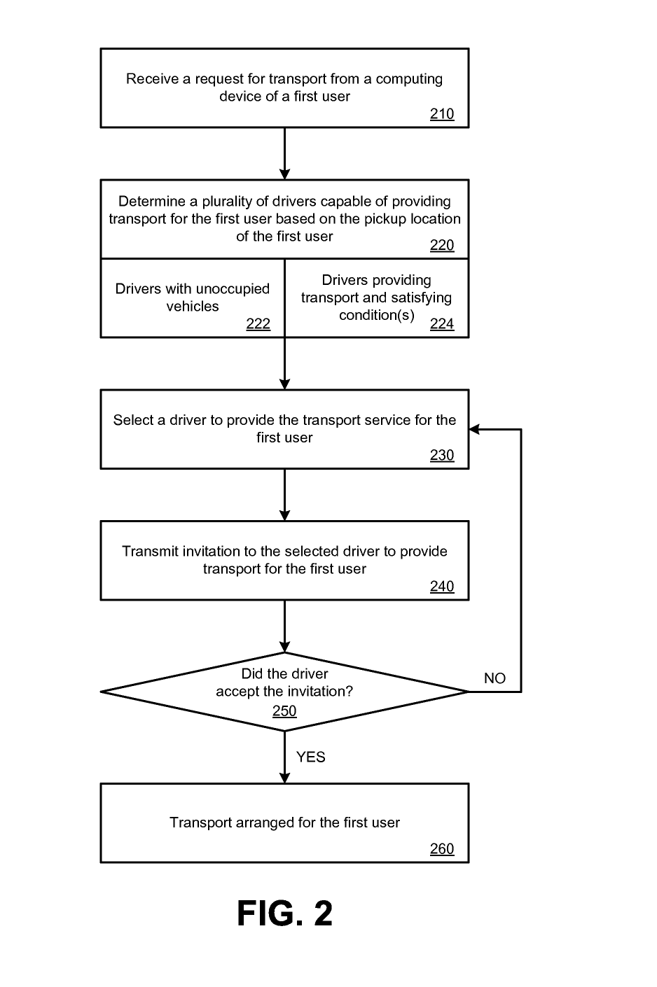

FIG. 2 illustrates an example method for arranging an on-demand service for a user, according to an example. A method such as described by an example of FIG. 2 can be implemented using, for example, components described with an example of FIG. 1A. Accordingly, references made to elements of FIG. 1A are for purposes of illustrating a suitable element or component for performing a step or sub-step being described.

Referring to FIG. 2, the system 100 can receive transport request 171 from a client device 170 of a first user (210). In one example, the transport request 171 can include a user ID 121, a pickup location 123, a vehicle type 125, and a destination location 127. The dispatch 110 can receive the transport request 171 (or information about the transport request 171) and determine a pool or plurality of drivers that are capable of providing transport for the first user based on the pickup location 123 of the first user (220).

For example, the pickup determination component 114 of the dispatch 110 can determine which drivers, from authorized and registered drivers with the on-demand service system 100, satisfy conditions that qualify the drivers as being capable of providing transport for the first user. The pickup determination component 114 can access the driver database 116 to determine a first set of drivers that are available (e.g., driving vehicles that are unoccupied) for providing transport and have a current location 113 that is within a predefined distance of the pickup location 123 and/or within a predefined region of the pickup location 123 (222).

For example, the first user can have a pickup location 123 in San Francisco, Calif. The pickup determination component 114 can determine which available drivers that are driving unoccupied vehicles are within five miles from the pickup location 123 or within the city limits of San Francisco (or within a particular neighborhood of the pickup location 123). The predefined distances or regions can be specified by an administrator of the system 100.

The pickup determination component 114 can also access the driver database 116 to determine a second (and/or third) set of drivers that are currently providing transport (e.g., are drivers that are in-use) and also satisfy one or more conditions related to the pickup location 123 of the first user (224). For example, the pickup determination component 114 can identify a second set of drivers that (i) are in-use, (ii) have respective current locations within a predefined distance of the pickup location 123 and/or within a predefined region of the pickup location 123, and (iii) are providing transport service to other users to respective destination locations that are within a threshold distance or threshold estimated 32 travel time from the pickup location 123 of the first user. In another embodiment, the pickup determination component 114 can also identify a third set of drivers that (i) are in-use, (ii) have respective current locations that are within a first threshold distance and/or first threshold estimated travel time of the pickup location 123, and (iii) have respective destination locations that is within a second threshold distance and/or second threshold estimated travel time from the destination location 127 of the first user.

The pickup determination component 114 can determine distance metrics and estimated travel time metrics based on the pickup location 127 of the first user, the current location of an active driver, the current location of an in-use driver, the destination location of an in-use driver, the destination location of the first user, and other factors, such as traffic conditions, predicted or most likely route, historical information of the driver and/or user, the time of day, event calendars, etc.

Once the plurality of drivers that are capable of providing transport for the first user is determined, the dispatch 110 can select a driver for the first user from the plurality of drivers (230). According to some embodiments, the driver select 118 can prioritize or rank the plurality of drivers and/or select a driver from the plurality of drivers based on one or more parameters or rules. Depending on implementation, the driver select 118 can prioritize the drivers based on one or more or a combination of one or more of (i) an active driver's distance from her current location to the pickup location 123 of the first user, (ii) an active driver's estimated travel time from her current location to the pickup location 123, (iii) an in-use driver's total distance from her current location to the pickup location 123, (iv) an in-use driver's total estimated travel time from her current location to the pickup location 123, (v) feedback information of a driver (vi) feedback information of the requesting user, (vii) whether any of the capable drivers have previously provided transport service for the requesting user, (viii) driver preferences, (ix) user preferences, (x) personal information about the driver, (xi) personal information about the user, (xii) the age of the driver's vehicle, and other factors.

In response to selecting a driver, the dispatch 110 can transmit an invitation to the selected driver to enable the driver to either accept or decline providing service for the first user (240). The invitation can include information about the first user (e.g., name, user name, photo, user's rating information) and the first user's pickup location (e.g., a GPS coordinate on a map, an address, a street intersection, etc.). When the selected driver operates his or her driver device, the invitation can enable the driver to select one of two selectable features, such as “Accept” or “Decline.” In another example, the selected driver's application can automatically accept the invitation (as the driver previously agreed to provide ride share services by specifying the ride share vehicle type). The dispatch system can then determine if the driver has accepted the invitation or automatically determine that the driver has accepted the invitation (250). If the driver rejects or declines the invitation, a decline message is provided to the dispatch system over one or more networks, and the dispatch system can select another driver (from the plurality of capable drivers) for the first user. The dispatch system can continue to select a subsequent driver for a user each time a driver declines an invitation until there are no more drivers capable of providing transport or if a time threshold is reached (e.g., no drivers accept the invitation within three minutes from the time the request is made, from the time the request is received by system 100, or from the time the first driver is selected). If the driver accepts the invitation, then the transport has been arranged for the first user, and information about the transaction for the transport is stored in databases of the system 100 (260). In addition, the first user can receive a notification or status message from the dispatch system that a driver has been selected for the user.

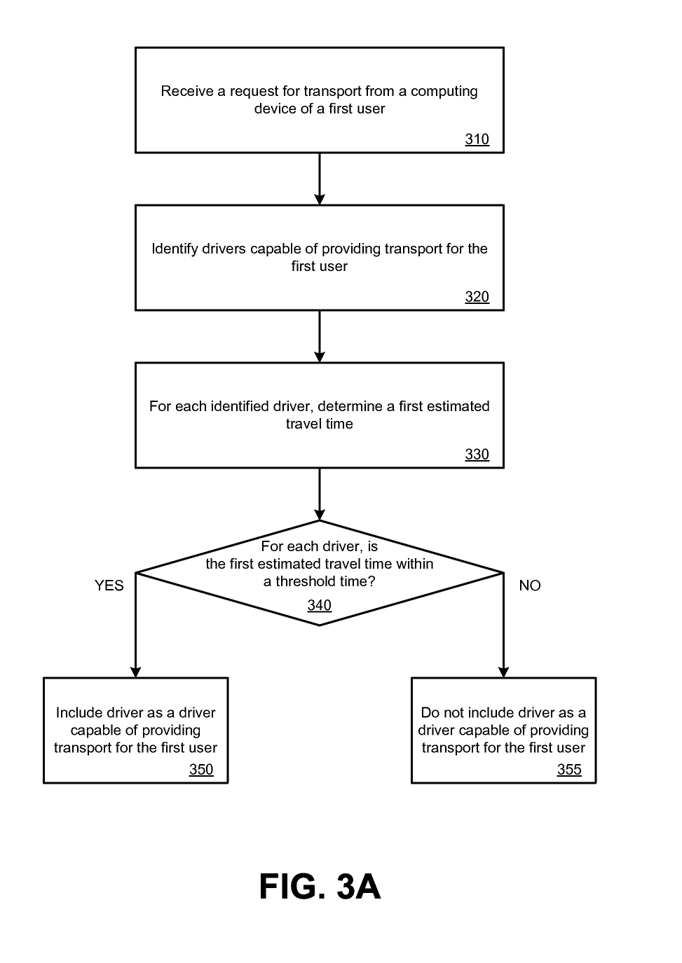

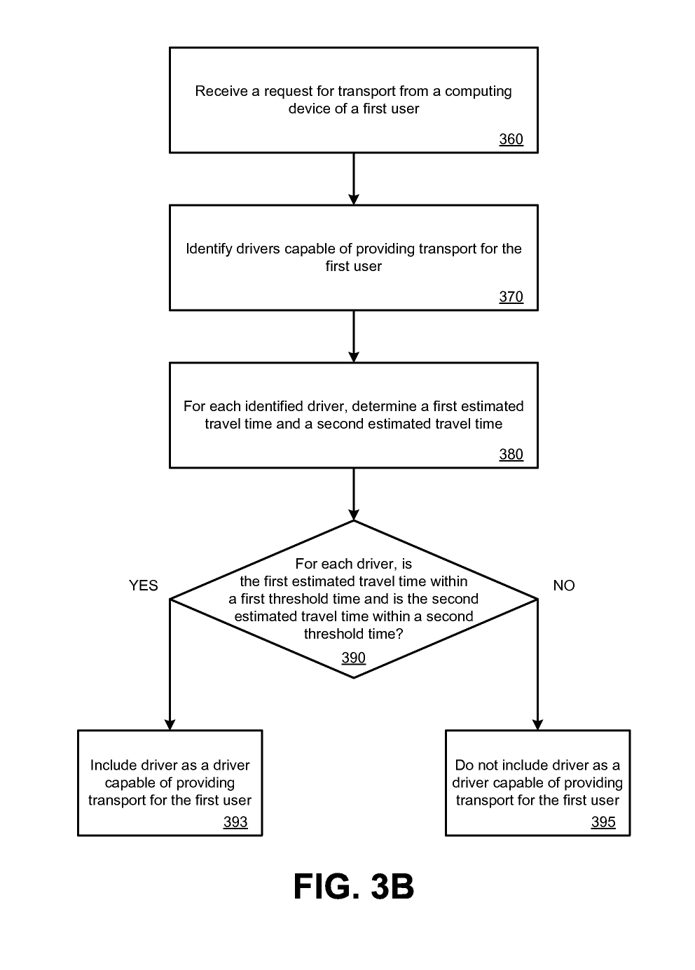

FIGS. 3A and 3B illustrate example methods for determining providers capable of providing an on-demand service, according to an example. Methods such as described by examples of FIGS. 3A and 3B can be implemented using, for example, components described with an example of FIG. 1A. Accordingly, references made to elements of FIG. 1A are for purposes of illustrating a suitable element or component for performing a step or sub-step being described.

FIG. 3A illustrates an example method for determining a plurality of in-use drivers that are capable of providing transport for a requesting user, according to an embodiment. In one example, the method of FIG. 3A (e.g., steps 320-355) can correspond to step 224 of FIG. 2. After the dispatch 110 receives a request for transport from a first user device (310), the pickup determination component 114 can identify in-use drivers that are providing transport to other users and that have a current location that is within a predefined region, distance, and/or estimated travel time from the pickup location of a first user (e.g., a requesting user) (320). In one example, the pickup determination component 114 can access the driver database 116 to determine real-time information about authorized or registered drivers.

For each identified in-use driver, the pickup determination component 114 can determine a corresponding respective destination location (e.g., a destination for the current user that an in-use driver is providing transport for). For each identified in-use driver, the pickup determination component 114 can perform a calculation or determine a first estimated travel time from the respective destination to the pickup location of the first user (330). In one example, the pickup determination component 114 can determine the estimated travel time based, at least in part, on a distance of travel for an estimated route of travel from the respective destination to the pickup location, current traffic conditions, historical routes taken by the driver and/or the current user that is being provided transport, time of day, weather conditions, etc.

The pickup determination component 114 can determine, for each identified in-use driver, whether the first estimated travel time is within a threshold time (340). If the first estimated travel time for a particular in-use driver is within the threshold time, the pickup determination component 114 includes that driver as a driver capable of providing transport for the first user (350). On the other hand, if the first estimated travel time for a particular in-use driver exceeds the threshold time, the pickup determination component 114 does not include that driver as a driver capable of providing transport for the first user (365).

As an addition or an alternative, the pickup determination component 114 can determine, for each identified in-use driver, a distance from the respective destination to the pickup location of the first user, and determine whether that distance is within a threshold distance. If that distance for a driver is within the threshold distance, the pickup determination component 114 can include that driver as a driver capable of providing transport for the first user. On the other hand, if that distance for a driver exceeds the threshold distance, the pickup determination component 114 does not include that driver as a driver capable of providing transport for the first user.

FIG. 3B illustrates another example method for determining a plurality of in-use drivers that are capable of providing transport for a requesting user, in at least some examples. In one example, the method of FIG. 3B (e.g., steps 370-395) can be performed by the dispatch 110 in conjunction with the method of FIG. 3A and/or can also correspond to step 224 of FIG. 2. The method of FIG. 3B corresponds to ride sharing between two or more users, e.g., a first user that is requesting a transport service and a second user that is already being provided transport by a corresponding driver.

In the example of FIG. 3B, it is assumed that the first user and the second user each indicated to the system 100 that he or she is willing to share a ride or transport with another user. For example, each of the first user and the second user may have requested transport by specifying a ride-share vehicle type (when making the request). In another example, each of the first user and the second user can operate his or her client device 170 to specify, as part of the user's profile, or update the user's profile, whether or not he or she is willing to share a transport, and the dispatch 110 can access the client database 150 to determine whether the first user is willing to share a ride. In one example, if the first user is not willing to share a transport, the pickup determination component 114 does not perform the method of FIG. 3B. Similarly, if a second user that is being provided transport is not willing to share a ride, the pickup determination component 114 does not include the corresponding driver as a driver that can pick up the first user while concurrently providing transport to the second user.

After the dispatch 110 receives a request for transport from a first user's device (360), the pickup determination component 114 can identify in-use drivers that are providing transport to other users and that have a current location that is within a predefined region, distance, and/or estimated travel time from the pickup location of a first user (e.g., a requesting user) (370). The pickup determination component 114 can access the driver database 116 to determine real-time information about authorized or registered drivers. For each identified in-use driver, the pickup determination component 114 can determine (i) a first estimated travel time from the current location of that driver to the pickup location of the first user, and (ii) a second estimated travel time from the respective destination location (e.g., a destination for the current user that an in-use driver is providing transport for) to the destination location of the first user (380). In some examples, the pickup determination component 114 can determine the first and second estimated travel times based, at least in part, on a distance of travel for an estimated route of travel from the respective destination to the pickup location, current traffic conditions, historical routes taken by the driver and/or the current user that is being provided transport, time of day, weather conditions, etc.

The pickup determination component 114 can determine, for each identified in-use driver, whether the first estimated travel time is within a first threshold time and whether the second estimated travel time is within a second threshold time (390). If the first estimated travel time for a particular in-use driver is within the first threshold time and the second estimated travel time for that driver is within the second threshold time, the pickup determination component 114 includes that driver as a driver capable of providing transport for the first user (3993). On the other hand, if the first estimated travel time for a particular in-use driver exceeds the first threshold time and/or the second estimated travel time for that driver exceeds the second threshold time, the pickup determination component 114 does not include that driver as a driver capable of providing transport for the first user (395).

As an addition or an alternative, the pickup determination component 114 can determine, for each identified in-use driver, a first distance from the current location of that driver to the pickup location of the first user and a second distance from the respective destination location to the destination location of the first user. The pickup determination component 114 can determine whether the first distance is within a first threshold distance and whether the second distance is within a second threshold distance. If the first distance is within the first threshold distance and the second distance is within the second threshold distance, the pickup determination component 114 can include that driver as a driver capable of providing transport for the first user. On the other hand, if the first distance exceeds the first threshold distance and/or the second distance exceeds the second threshold distance, the pickup determination component 114 does not include that driver as a driver capable of providing transport for the first user.

FIG. 4 illustrates a method for optimizing the selection of drivers (or vehicles) for transport requests, according to one or more examples. A method such as described with an example of FIG. 4 can be implemented using, for example, a system such as described with an example of FIG. 1A, and an optimization sub-system such as described with either FIG. 1B or FIG. 1C. Accordingly, reference may be made to elements of FIG. 1A for purpose of illustrating a suitable component or element for performing a step or sub-step being described.

With reference to an example of FIG. 4, a pairing pool can be determined at a given geographical region (410) reflecting demand (transport requests 412) and supply (pool of drivers 414) for a given geographic region at a given moment in time.

At a given duration, the pool of transport requests can include, depending on implementation variations, one or more of pre-pickup requests (415), open pickup requests (416), and/or tentatively fulfilled pickup requests (417). Pre-pickup requests can be generated from client devices 170 which are operated in a manner that indicates a high probability or likelihood that a transport request is about to be made. By way of example, the client devices 170 can include a service application for communicating with the system 100 (when implemented as a network service), which can generate background communications that are indicative of a user's intent to request transport. Thus, for example, the pre-pickup request can correspond to activity detected through the client interface 120 of the system 100, including the launching of a service application in one of the client devices, as well as other activities such as communication from the service application of position information which indicate the user is walking to a corner or location that is known as being a location from which the user or other individuals make transport requests. In one implementation, the pool of drivers are determined for one or multiple transport requests that are communicated from a particular geographical region (e.g., square mile of city) in a given duration of time (e.g., one minute).

The open transport request refers to a communicated transport request that has not been fulfilled (416). The transport requests can be generated through operation of client devices on which a service application is executed. A user can generate a transport request by, for example, selecting an iconic input, resulting in (i) programmatic determination of the user location (e.g., current location, or user provided map input or address), and (ii) communication of a transport request to the system 100 which specifies or embeds a determined or specified location of the client device 170.

Still further, the pool of transport request can also include those transport requests which have been recently fulfilled, but which have the designation of being tentative (417). As described with other examples, such designations can be made by the system 100 when, for example, there is the possibility that a better pairing can be provided to the particular transport request a short time in the future.

On the supply side, the pool of drivers can include both available and candidate drivers. Available drivers include those drivers which have a service state of being open, meaning the drivers operate corresponding vehicles that, at the considered moment in time, are located within the considered geographic region. However, the drivers are not in use and they are not assigned to a particular transport request (425).

In some variations, the pool of drivers can include candidate vehicles which are in use and also within a threshold distance from the considered geographic region or pickup location (426). Such drivers can be candidates for the driver pool because of the likely drop-off location for their respective current fare. For example, in one implementation, the candidate drivers can include those drivers which (i) have a service state of being in use, (ii) have a likely or known drop-off location that is within the geographic region being considered, and/or (iii) are currently within a designated or threshold range of their respective drop-off point.

In some variations, the pool of drivers can include those vehicles which have been assigned to a transport request, but only just within a short period of time prior to the determination being made (427). For example, such candidate drivers can include those which have been assigned to a transport request in the immediate prior 60 seconds. Other conditions which may need to be satisfied in order for such drivers to be considered candidates include (i) the particular driver has not yet arrived to his or her assigned pickup location, and/or (ii) the reassignment of the driver would not be in violation of any business logic rule which would otherwise preclude the driver from being reassigned at that particular instance (e.g., if the driver was recently reassigned, and a rule precluded one driver to be reassigned more time once in a given duration of time).

Once the respective pool of transport requests and drivers are determined for a given duration and geographic region, candidate pairings can be made as between the transport request and drivers (430). In one of implementation, each transport request of the demand pool is hypothetically paired to each driver in the supply pool, in order to determine time to pick up for each hypothetical pairing. Thus, for example, if the demand includes three transport requests and the available supply includes three drivers, then nine hypothetical pairings may be possible, and for each pairing, a time to pick up is determined. From the time to pick up determination for the hypothetical pairings, the optimal time to pick up is determined in accordance with an optimization objective (432). In one example, the optimization objective is to find the optimal pairing as between a single transport request and a pool of multiple drivers (434). Thus, if multiple transport requests exist at one time, each transport request can be treated individually, and selected for treatment on, for example, a first-come first-serve basis. The optimal pairing for a given transport request can correspond to the driver which has a minimal time to pick up for that transport request.

In variations, the optimization objective can correspond to minimizing the average or aggregate time to pick up for a group of multiple transport requests (436). Thus, if multiple transport requests exist at one time, the optimization determination can pair drivers to transport request so that the average pickup time for each transport request is minimized, given the pool of drivers at that particular moment or duration of time.

The driver pickup selections can be made based on the optimal time to pick up determinations (440). For example, when the optimization objective is to optimize the time to pick up for individual transport requests, then the driver for the particular transport request can be selected for being closest in time to arriving at the pickup location. When the optimization objective is to optimize the time to pick up for multiple transport requests, then the driver and transport pairings is optimized based on a consideration of minimizing the aggregate time to pick up for all of the transport requests in the particular group of transport requests, so that, for example, the average time to pick up for the group of transport requests is minimized. In variations, the aggregate time to pick up for all of the transport requests in the particular group can be minimized based on other parameters, such as minimizing the median of the time to pick up for the transport requests of the group, or excluding outlier times to pick up from consideration in the optimization objective. Numerous variations to the manner in which optimization is performed on either the single or group transport request model can be utilized, resulting an intelligent and deliberate driver and transport request pairings which reduce the time to pick up as compared to, for example, random pairings or other selection processes (e.g., “greedy” process in which each transport request is fielded to a group of drivers for first respondent, etc.).

The assignments of drivers to transport requests can include new driver assignments (442) and driver reassignments (444). In some variations, new driver assignments include tentative assignments (445) and committed assignments (446). Tentative assignments reflect a system setting which allows for the dispatch 110 to reassign a transport request from one driver to another. Committed assignments, on the other hand, are final selections. In one implementation, the dispatch 110 can determine committed assignments only. In variations, the dispatch 110 can determine tentative assignments in some cases, and after some condition is met (e.g., passage of time since the driver was tentatively assigned, the proximity of the driver to the pickup location, and/or the driver arriving at the pickup location), the tentative assignment can become committed or final.

The driver reassignments can include those which change the driver for a particular transport request (447) (see FIG. 5A), as well as those that swap drivers (or transport requests) (448) (see FIG. 5B). A driver can be reassigned from a particular pickup location based on an optimization determination, when, for example, (i) another driver is added to the driver pool which can arrive at the particular pickup location sooner, (ii) another transport request is added to the inventory pool which provides a more optimal result for the currently assigned driver to handle, and/or (iii) either (i) or (ii), when the reassignment results in a better group optimization.

An optimization process such as described with an example of FIG. 4 can be triggered into implementation with the occurrence of a condition or event (450). The condition can include the passage of time (452). For example, the determination of inventory (transport request) and supply (drivers) can be made at discrete time intervals (e.g., every minute) and for specific geographic regions (e.g., mile-diameter). Alternatively, either the driver or transport pools can be determined on a continual basis (e.g., continuously or periodically repeat the steps described in FIG. 4) (460). Still further, the implementation of an optimization function for time to pick up can be implemented progressively through the inventory of transport requests, and with passage of time, new transport requests are entered and provided as part of the pool. In variations, the optimization process can be triggered with the occurrence of an event, such as the open inventory reaching a given size at a given time period (454).

Still further, the particular optimization objective in use can be selected based on the occurrence of events or conditions. For example, in one implementation, a single transport request objective can be employed when driver supply readily meets demand from transport requests. Furthermore, the optimization objective can be switched to a group objective when driver supply does not meet demand from transport requests.

FIG. 5A illustrates an example sequence diagram for a driver assignment and subsequent change based on optimization considerations, according to an example. In an example of FIG. 5A, a service 520 can be implemented by, for example, a system 100 of FIG. 1A in order to provide transport to a client device 510 from which a transport request 511 is made. The transport request 511 can be generated from the client device 510 to communicate a pickup location 513. The transport request 511 and pickup location 513 can be received by the service 520. The service 520 can also receive location information 531 from one or more drivers (operating driver devices 530) which are within a designated geographic region from the pickup location. The driver which communicate the location information can have any one of multiple possible service states 533, including states of in-use, open, and/or tentatively assigned. Depending on the implementation, the transport request 511 can be optimized by the service 520 based on an optimization objective that either considers the transport request 511 individually or as part of a group of transport requests. In the former case, the service 520 implements an optimization process 522 to determine, at T=1, a driver 532 in accordance with the optimization objective.

The selection 521 of a driver 532 from the driver pool 530 can be made at a given time or time duration. As shown by an example of FIG. 5A, the selection of the driver 532 can be tentative, at least for a given duration of time, meaning the selection of the driver for client 510 can subject to change. The change can be triggered by an alternative optimization outcome after the selection 521 is made. Upon the initial selection 521 being made, the service 520 can signal a confirmation 525 to the client device 510. However, during the time period in which the selection of the driver 532 is tentative, the confirmation communication 525 from the network service 520 can be non-specific. For example, no information about the selected driver 532 may be displayed.

Additionally, when selection 521 is made at T=1, the driver 532 can operate the vehicle to travel towards the pickup location of the client device 510. However, even though the driver 532 has initiated traveling towards the pickup location, an implementation of FIG. 5A provides that, for a duration following the initial selection of driver 532, the driver assigned to the transport request 511 can be reassigned.

In more detail, a second driver 534 (operating a corresponding driver device) can arrive or otherwise be identified in the geographic region of the transport request (e.g., the driver 534 turns on the driver device 180). The second driver 534 can communicate location information 535 and service state 537 in order to be detected and evaluated for inclusion in a driver group. The second driver 534 can be added to the driver pool 530 when, for example, the second driver is first detected to be within the geographic region or within some threshold distance of the pickup location. In one implementation, the second driver can receive reassignment of the transport request 511 if (i) the second driver 534 can arrive at the pickup location, and/or (ii) the time of assignment for the first driver 532 is within a corresponding threshold period of time (e.g., less than one minute). In a variation, the second driver can receive reassignment of the transport request 511 if the optimization objective is met. For example, if a single transport request objective is employed, then the comparison of the time to pick up as between the second and first drivers 534, 532 can be determinative. If, on the other hand, a group transport request objective is in use, then the reassignment would need to also meet the group objective (e.g., result in reduction of average time to pick up for entire group). In the example provide, the updated optimization process 524 compares the first driver 532 and second driver 534 by location, as compared to the pickup location, in determining that the second driver 534 provides the more optimal time to pick up. At T=2, the service 520 communicates the selection 523 to the device 180 of the second driver 534, and further communicates an identifier 527 of the second driver 534 to the client device 510. In one implementation, once the identifier for the driver is communicated to the pickup location device, then the selection of the second driver becomes committed. Additionally, once the second driver is selected, the first driver 532 receives a cancellation order 529.

FIG. 5B illustrates another example sequence diagram of a trip (or driver) swap based on optimization considerations, according to another example. In an example of FIG. 5B, a service 560 can be implemented by, for example, a system 100 of FIG. 1A in order to provide transport to a client device (or transport request) pool 550 from which a transport request 551 is made. The transport request 551 can be generated from the first client device 552 to communicate a first transport request 551 and pickup location 553. The transport request 551 and pickup location 553 can be received by the service 560. Additional transport requests can be received by the network service 560 from other client devices, including a second transport request 555 and pickup location 557 from a second client device 554.

As with an example of FIG. 5A, the service 560 may receive location information 571 from one or more drivers (operating driver devices, shown as driver pool 570). The identified drivers 572, 574 may be selected to be within a designated geographic region from the pickup location. The drivers which communicate the location information 571 can have any one of multiple possible states 573, including states of in-use, open, and/or tentatively assigned.

In an example of FIG. 5B, multiple transport requests 551, 555 are initially generated by client devices 552, 554 to form the client device (or demand) pool 550. Each transport request 551, 555 can be associated with a corresponding pickup location 553, 557. The service 560 implements an optimization process 562 at T=1, in order to select 581 the driver 572 from the driver pool 570 for the first client device 552. Likewise, the second driver 574 can communicate the location information 571, which is used to select the second driver for the second client device 554. An optimization process 562 can select 581, 583 each of (i) the first driver 572 from the driver pool 570 for the first client device 552, and (ii) the second driver 574 from the driver pool 570 for the second client device 554. The selections can be generated from the optimization process 562, which provides for considerations such as the time to pick up for the first client device 552 by the first driver. With each selection 581, 583, the corresponding client device 552, 554 is signaled a confirmation 567, 569 which omits driver identification.

By monitoring the locations 571, 573 of the first and second drivers 572, 574, as well as the pickup location 553, 557 of the respective first and second devices 552, 554, the network service can detect an event or change that would cause it to reconsider the optimization determinations for the original driver selections. For example, the pickup location for one client device may change, or one driver may encounter traffic. Still further, the demand pool of transport requests can expand with new users requesting transports. These events can require re-evaluation of the optimal pairings amongst the limited supply of drivers and vehicles. In these and other cases, the service 560 can perform an updated optimization process 564 in order to continuously or repeatedly calculate optimal driver selections for each of the client devices and their respective transport request 551, 555. In one example, the service 560 performs a trip swap upon determining that the more optimal solution (e.g., in terms of group time to pick up) is to swap the assignment of the first and second drivers 572, 574. The trip swap can be performed at T=2, after when the original driver assignments have been made. In order to swap the assignments, a re-selection 583 is communicated to the first driver 572, to provide the pickup location 557 and other information from the second transport request 555. Additionally, a re-selection 587 is communicated to the second device 574 to provide the pickup location 553 and other information of the first transport request 551. Additionally, driver identification 561 for the second driver is communicated to the first client device 552, and driver identification 563 for the first driver is communicated to the second client device 554.

### Examples for Group Optimization

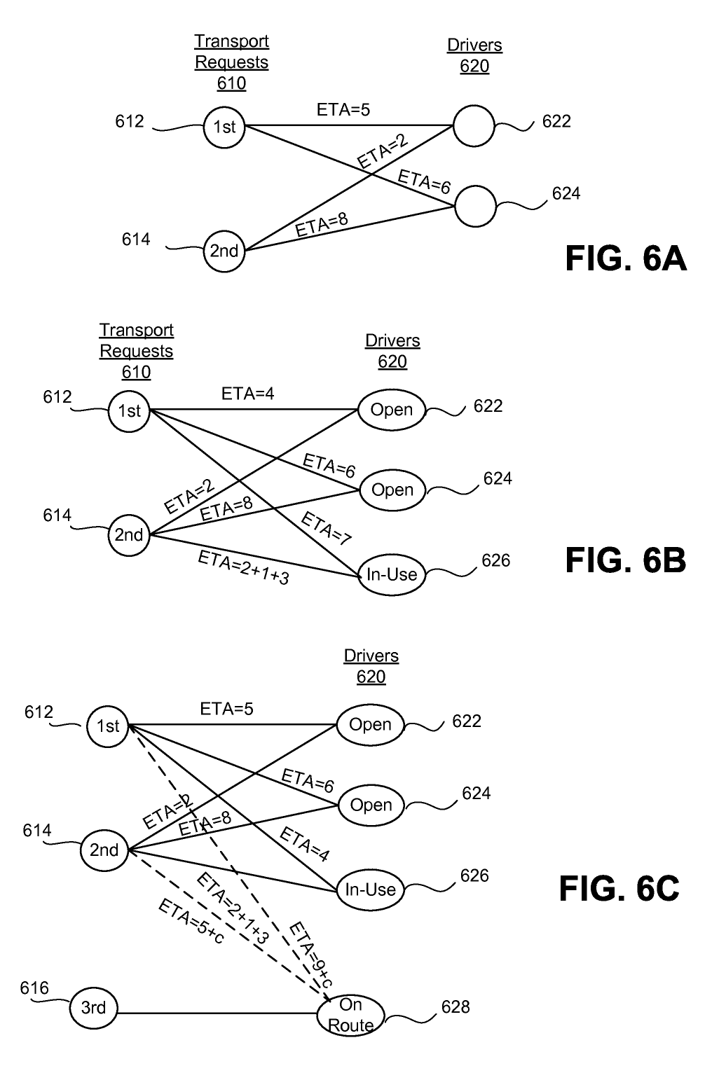

FIG. 6A through FIG. 6C illustrate examples for implementation of a driver selection algorithm(s) in which driver/rider pairings are made with an optimization objective of minimizing time to pick up, according to one or more examples. While examples of FIG. 6A through FIG. 6C illustrate a relatively small number of riders and drivers, the examples provided are intended to illustrate application of the concepts described, and as such, the examples described with FIG. 6A through FIG. 6C can be extended in application to larger rider and driver pools.

In FIG. 6A, the demand pool (client devices making transport requests 610) includes the first and second device 612, 614. The supply or driver pool 620 (drivers that are available) can include first and second drivers 622, 624. In order to make driver/rider pairings in accordance with a group objective function, the time to pick up (described as estimated time of arrival or ETA) as between each driver and pickup location is determined.

In the example provided, four hypothetical pairings are possible, and the system 100 determines the time to pick up for each: (i) first device 612 and first driver 622 (time to pick up of 5 minutes), (ii) second device 614 and second driver 624 (time to pick up of 8 minutes), (iii) first device 612 and second driver 624 (time to pick up of 6 minutes), and (iv) second device 614 and first driver 622 (time to pick up of 2 minutes). In order to optimize the time to pick up for each driver individually, then one driver is optimized first (e.g., first in time to request transport). For example, if the first device 612 is optimized first, then the first device 612 is paired with the first driver 622, leaving the second rider 614 paired with the second driver 624. This results in a group time to pick up average of 6.5 minutes. While this outcome is favorable for the first driver 612 (e.g., using single transport request optimization objective), when considered for the group (first driver 612 and second driver 614), the pairing is not optimal. When the objective of optimization is extended to the group, the optimal pairing is to pair the second rider 614 with the first driver 622, and the first rider 612 with the second driver 624. This results in a group time to pick up average of 4 minutes, but the time to pick up for the first driver increases by one minute.

The determination as to whether single or group optimization objectives are to be used can be one of design or implementation choice. In some variations, the determination of whether the group or single transport objective is to be utilized can be determined based on comparisons of results. For example, if one optimization objective (single optimization objective) yields a much better result for one rider without costing significant time to pick up for another driver (e.g., difference between single and group optimization for some or more other drivers is less than a threshold), then the determination can be to use the single optimization objective at least for the one rider that receives the large benefit, with the remainder being subjected to single or group optimization objective.

In FIG. 6B, a variation is shown in which one driver 626 of the driver pool 620 has a service status of being in-use, while the other drivers 622, 624 have a service status of open (or not in-use). The in-use driver 626 can be added to the pool of candidate drivers, but the in-use driver time to pick up for one of the riders 612, 614 includes additional time that includes time-to-drop-off of existing fare (customer being transported) and drop-off time. The drop-off time for the in-use driver 626 can be treated as an additive constant (e.g., 1 minute, representing time for existing fare to depart vehicle), and the time-to-pick up for the on-route driver 626 can be calculated as the sum of (i) the time-to-point of destination (e.g., 2 minutes in FIG. 6B), (ii) the additive constant (e.g., 1 minutes in FIG. 6B), and (iii) the time of travel from the point of destination to the pickup point (e.g., 3 minutes in FIG. 6B). With the additional driver, the single or group objective optimization can be performed. For example, under the group objective, the driver 626 is assigned to the second rider 614, and the first driver 622 is assigned to the first rider 612 so that the average time to pick up for both riders is 5 minutes. As shown by an example of FIG. 6B, the in-use driver 626 represents a better alternative than the second driver 624 with regard to at least the second rider 614, and substitution of the in-use driver 626 reduces the aggregate measure of time-to-pickup for both riders 612, 614.

In FIG. 6C, the driver pool 620 includes the addition of an on route (or tentatively assigned) driver 628. The on route driver can be considered in the driver pool based on his current position. In particular, the on route driver 628 can be reassigned to, for example, the second rider 614 if the group optimization objective is met. However, the original rider 616 for the on route driver 628 has lost his driver, and must await a new driver, resulting in longer wait. In this regard, the reassignment of rider 616 adds a cost (c) representing the time it takes to assign a new driver to the third rider 616. In an example of FIG. 6C, the cost (c) is measured in terms of minutes or time. While reassignment of driver 628 to one of the riders 612, 614 can save time with regard to the aggregate, it adds time to at least the original rider 616. If the original third rider 616 is included in the aggregate optimization, the time cost of reassignment can be reduced or ignored as the calculation would inherently factor in the reassignment for the third rider. However, even in such cases, reassignment represents an incremental cost in that the reassigned driver needs to be notified and then change routes (e.g., perform U-turn, switch back). The incremental cost can be modeled to factor events such as risks (e.g., re-assigned driver fails to make optimal transition to new rider) and loss of goodwill (e.g., rider 616 loses time-to-pickup). In one implementation, the incremental cost can be represented in terms of unit of time.

To further an example of FIG. 6C, a driver can be reassigned to a rider that already received a driver assignment, meaning one driver may lose an assignment when driver reassignment occurs. The driver loss can also be represented by a cost (c) expressed in terms of time (e.g., expected time for driver to receive new assignment) or other measure. Thus, the cost (c) can include inefficiency of reassignment as between reassigned passengers and drivers, as well as loss of goodwill.

### Hardware Diagrams

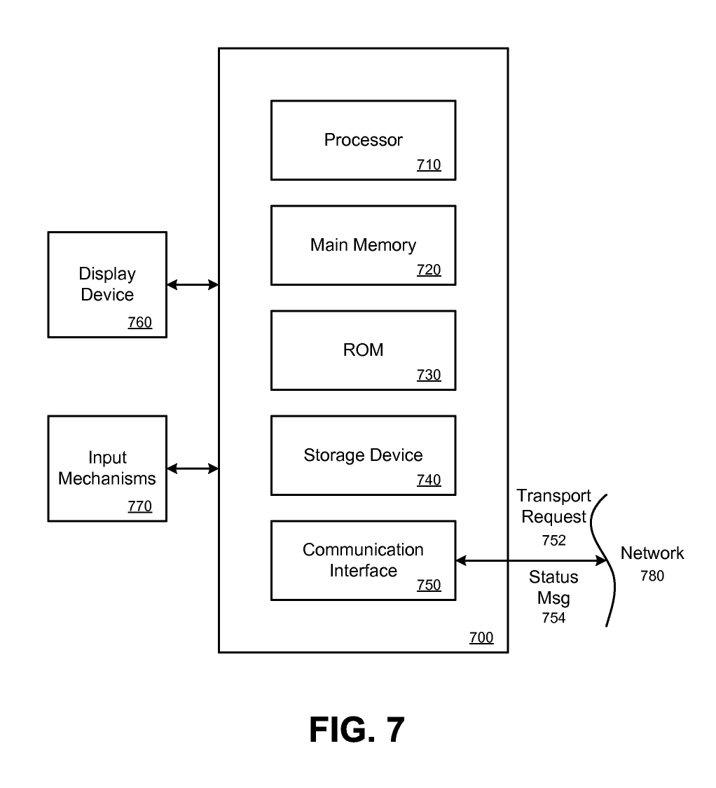

FIG. 7 is a block diagram that illustrates a computer system upon which examples described herein may be implemented. For example, in the context of FIG. 1, the system 100 may be implemented using a computer system such as described by FIG. 7. The system 100 may also be implemented using a combination of multiple computer systems as described by FIG. 7.

In one implementation, a computer system 700 includes processing resources 710, a main memory 720, a read-only memory (ROM) 730, a storage device 740, and a communication interface 750. The computer system 700 includes at least one processor 710 for processing information and the main memory 720, such as a random access memory (RAM) or other dynamic storage device, for storing information and instructions to be executed by the processor 710. The main memory 720 also may be used for storing temporary variables or other intermediate information during execution of instructions to be executed by the processor 710. The computer system 700 may also include the ROM 730 or other static storage device for storing static information and instructions for processor 710. The storage device 740, such as a magnetic disk or optical disk, is provided for storing information and instructions, such as instructions to implement the dispatch 110 and optimization logic 128 of FIG. 1A, and various databases.

The communication interface 750 can enable the computer system 700 to communicate with one or more networks 780 (e.g., cellular network) through use of the network link (wireless or wireline). Using the network link, the computer system 700 can communicate with one or more computing devices, and one or more servers. In some variations, the computer system 700 can be receive a transport request 752 from a client device of a user via the network link. The transport request 752 can include the user's user identifier, a pickup location, a destination location, and a vehicle type selection. The transport request 752 can be processed by the processor 710 to determine a plurality of drivers that are capable of providing transport service for the user. The processor 710 can determine the plurality of drivers based on the user's pickup location and the drivers' respective statuses, drivers' respective current locations, and the driver's respective destination locations. When a driver is selected from the plurality of drivers, the processor 710 can transmit, over the network 780, a status message 754 to the client device (e.g., that made the transport request) notifying the user that a driver has been selected (e.g., based on optimization) and/or to a computing device of the selected driver notifying the driver that he or she has been selected to provide a transport service for the user.

The computer system 700 can also include a display device 760, such as a cathode ray tube (CRT), an LCD monitor, or a television set, for example, for displaying graphics and information to a user. An input mechanism 770, such as a keyboard that includes alphanumeric keys and other keys, can be coupled to computer system 700 for communicating information and command selections to the processor 710. Other non-limiting, illustrative examples of input mechanisms 770 include a mouse, a trackball, touch-sensitive screen, or cursor direction keys for communicating direction information and command selections to the processor 710 and for controlling cursor movement on the display 760.

Examples described herein are related to the use of the computer system 700 for implementing the techniques described herein. According to one example, those techniques are performed by the computer system 700 in response to the processor 710 executing one or more sequences of one or more instructions contained in the main memory 720. Such instructions may be read into the main memory 720 from another machine-readable medium, such as the storage device 740. Execution of the sequences of instructions contained in the main memory 720 causes the processor 710 to perform the process steps described herein. In alternative implementations, hard-wired circuitry may be used in place of or in combination with software instructions to implement examples described herein. Thus, the examples described are not limited to any specific combination of hardware circuitry and software.

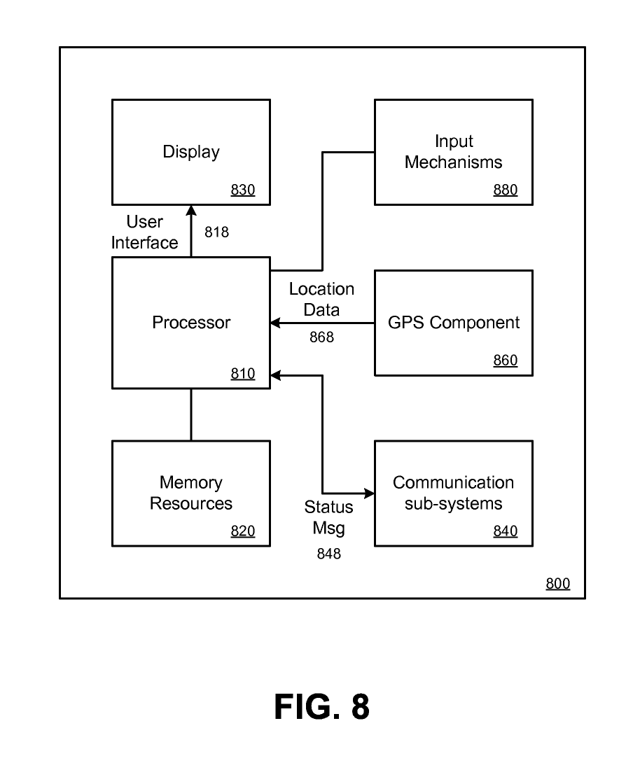

FIG. 8 is a block diagram that illustrates a mobile computing device upon which examples described herein may be implemented. In one embodiment, a computing device 800 may correspond to a mobile computing device, such as a cellular device that is capable of telephony, messaging, and data services. The computing device 800 can correspond to a client device or a driver device. Examples of such devices include smartphones, handsets or tablet devices for cellular carriers. The computing device 800 includes a processor 810, memory resources 820, a display device 830 (e.g., such as a touch-sensitive display device), one or more communication sub-systems 840 (including wireless communication sub-systems), input mechanisms 850 (e.g., an input mechanism can include or be part of the touch-sensitive display device), and one or more location detection mechanisms (e.g., GPS component or receiver) 860. In one example, at least one of the communication sub-systems 840 sends and receives cellular data over data channels and voice channels.

The processor 810 is configured with software and/or other logic to perform one or more processes, steps and other functions described with implementations, such as described by FIGS. 1 through 7, and elsewhere in the application. The processor 810 is configured, with instructions and data stored in the memory resources 820, to operate a service application as described in FIGS. 1 through 7. For example, instructions for operating the service application in order to display user interfaces can be stored in the memory resources 820 of the computing device 800.

A user can operate a client device (such as a computing device 800) to operate a service application in order to make a request for a transport service. A location data point 865, such as a location data point corresponding to the current location of the computing device 800, can be determined from the GPS component 870. The location data point 865 can be wirelessly transmitted to the system via the communication sub-systems 840 as part of the request for the transport service. In another example, the user can specify a different location data point than the current location of the computing device as the pickup location (e.g., by inputting an address or making a selection on a map via the input mechanisms 850) to be transmitted as part of the request for transport. The intelligent dispatch system can receive the request from the computing device 800 and perform a driver selection process for the user. The system can transmit a status message(s) 845 regarding the driver selection to the computing device 800 via the communication sub-systems 840. The status messages 845 can be processed by the processor 810 to provide the status information to the user as part of a user interface 815 on the display 830.

For example, the processor 810 can provide a variety of content to the display 830 by executing instructions and/or applications that are stored in the memory resources 820. One or more user interfaces 815 can be provided by the processor 810, such as a user interface for the service application, which can include the information corresponding to the status messages 845. While FIG. 8 is illustrated for a mobile computing device, one or more embodiments may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A method for arranging a transport service, the method being performed by one or more processors of a server and comprising:
receiving, from a computing device of a first user, a request for transport, the request for transport including information about a pickup location of the first user;
in response to receiving the request for transport, determining a plurality of drivers that are capable of providing transport for the first user by (i) determining a first set of drivers that are each driving a vehicle that is unoccupied by other users, and (ii) determining a second set of drivers that are each providing transport service to one or more other users to a respective destination location that is within a threshold distance or threshold estimated travel time from the pickup location of the first user; and
from the plurality of drivers, selecting a first driver to provide the transport service for the first user.

2. The method of claim 1, wherein determining the first set of drivers includes determining that each driver in the first set of drivers has updated a respective status indicating that the driver is available to provide transport service.

3. The method of claim 1, wherein each of the second set of drivers transmits, to the server over one or more networks, information about the respective destination location using a corresponding computing device.

4. The method of claim 1, wherein determining the first set of drivers that are driving vehicles that are unoccupied by users includes identifying drivers that are driving vehicles that are unoccupied by users having a current location within a predefined distance of the pickup location of the first user.

5. The method of claim 4, wherein determining the second set of drivers includes (i) identifying drivers that are providing transport service to other users, the identified drivers having a current location within the predefined distance of the pickup location of the first user, (ii) for each identified driver, determining a first estimated travel time from that respective destination location to the pickup location of the first user, and (iii) for each identified driver, comparing the first estimated travel time with the threshold estimated travel time.

6. The method of claim 5, further comprising:
determining, for each driver in the first set of drivers, an estimated travel time from a current location of that driver to the pickup location of the first user; and
determining, for each driver in the second set of drivers, a total estimated travel time, the total estimated travel time corresponding to a sum of the first estimated travel time and a second estimated travel time from the current location of that driver to the respective destination location.

7. The method of claim 6, wherein selecting the first driver to provide the transport service for the first user includes selecting, from the plurality of drivers, a driver having the least total estimated travel time.

8. The method of claim 1, further comprising:
transmitting, to a computing device of the selected first driver, a message inviting the first driver to provide the transport service for the first user, the message enabling the first driver to accept or reject the transport service.

9. A non-transitory computer-readable medium storing instructions that, when executed by one or more processors of a server, cause the server to perform operations comprising:
receiving, from a computing device of a first user, a request for transport, the request for transport including information about a pickup location of the first user;
in response to receiving the request for transport, determining a plurality of drivers that are capable of providing transport for the first user by (i) determining a first set of drivers that are each driving a vehicle that is unoccupied by other users, and (ii) determining a second set of drivers that are each providing transport service to one or more other users to a respective destination location that is within a threshold distance or threshold estimated travel time from the pickup location of the first user; and
from the plurality of drivers, selecting a first driver to provide the transport service for the first user.

10. The non-transitory computer-readable medium of claim 9, wherein the instructions cause the server to determine the first set of drivers that are driving vehicles that are unoccupied by users by determining that each driver in the first set of drivers has updated a respective status indicating that the driver is available to provide transport service.

11. The non-transitory computer-readable medium of claim 9, wherein each of the second set of drivers transmits, to the server over one or more networks, information about the respective destination location using a corresponding computing device.

12. The non-transitory computer-readable medium of claim 9, wherein the instructions cause the server to determine the first set of drivers that are driving vehicles that are unoccupied by users by identifying drivers that are driving vehicles that are unoccupied by users having a current location within a predefined distance of the pickup location of the first user.

13. The non-transitory computer-readable medium of claim 12, wherein the instructions cause the server to determine the second set of drivers by (i) identifying drivers that are providing transport service to other users, the identified drivers having a current location within the predefined distance of the pickup location of the first user, (ii) for each identified driver, determining a first estimated travel time from that respective destination location to the pickup location of the first user, and (iii) for each identified driver, comparing the first estimated travel time with the threshold estimated travel time.

14. The non-transitory computer-readable medium of claim 13, wherein the instructions cause the server to perform operations further comprising:
determining, for each driver in the first set of drivers, an estimated travel time from a current location of that driver to the pickup location of the first user; and
determining, for each driver in the second set of drivers, a total estimated travel time, the total estimated travel time corresponding to a sum of the first estimated travel time and a second estimated travel time from the current location of that driver to the respective destination location.

15. The non-transitory computer-readable medium of claim 14, wherein the instructions cause the server to select the first driver to provide the transport service for the first user by selecting, from the plurality of drivers, a driver having the least total estimated travel time.

16. The non-transitory computer-readable medium of claim 9, wherein the instructions cause the server to perform operations further comprising:
transmitting, to a computing device of the selected first driver, a message inviting the first driver to provide the transport service for the first user, the message enabling the first driver to accept or reject the transport service.

17. A method for arranging a transport service, the method being performed by one or more processors of a server and comprising:
receiving, from a computing device of a first user, a request for transport, the request for transport including information about a pickup location of the first user;
in response to receiving the request for transport, determining a plurality of drivers that are each providing transport service to one or more other users to a respective destination location that is within a threshold estimated travel time from the pickup location of the first user; and
from the plurality of drivers, selecting a first driver to provide the transport service for the first user.

18. The method of claim 17, wherein determining the plurality of drivers includes (i) identifying drivers that are providing transport service to other users, the identified drivers having a current location within the predefined distance of the pickup location of the first user, (ii) for each identified driver, determining a first estimated travel time from that respective destination location to the pickup location of the first user, and (iii) for each identified driver, comparing the first estimated travel time with the threshold estimated travel time.

19. The method of claim 17, further comprising:
determining, for each driver of the plurality of drivers, a total estimated travel time, the total estimated travel time corresponding to a sum of the first estimated travel time and a second estimated travel time from the current location of that driver to the respective destination location; and
wherein selecting the first driver to provide the transport service for the first user includes selecting, from the plurality of drivers, a driver having the least total estimated travel time.

20. The method of claim 17, further comprising:
transmitting, to a computing device of the selected first driver, a message inviting the first driver to provide the transport service for the first user, the message enabling the first driver to accept or reject the transport service.
